(19) United States
(12) Patent Application Publication
(10) Pub. No.: US 2012/0190004 A1
(43) Pub. Date: Jul. 26, 2012

(54) METHODS AND COMPOSITIONS FOR THE CRYOPRESERVATION OF DUCKWEED

(75) Inventors: John L. Parsons, Pittsboro, NC (US); Vincent Wingate, Chapel Hill, NC (US)

(73) Assignee: Biolex Therapeutics, Inc., Pittsboro, NC (US)

(21) Appl. No.: 13/379,959

(22) PCT Filed: Jun. 22, 2010
(86) PCT No.: PCT/US2010/039453

§ 371 Date: Mar. 9, 2012

Related U.S. Application Data
(60) Provisional application No. 61/219,578, filed on Jun. 23, 2009.

(51) Int. Cl. A01N 1/02

(52) U.S. Cl. 435/1.3

(57) ABSTRACT

The present invention describes methods for the cryopreservation of duckweed plants and duckweed plant tissues. The methods comprise freezing a dehydrated duckweed frond colony to a cryopreservative temperature to obtain a frozen frond colony comprising at least one cryopreserved duckweed plant or a cryopreserved duckweed plant tissue. The method can comprise a dehydration step whereby a duckweed frond colony is dehydrated, and in some embodiments, can further comprise a dormancy-induction step prior to or during the dehydration step. The method further can further comprise a recovery step, wherein the frozen frond colony is thawed and a viable duckweed plant or duckweed plant tissue is recovered. Cryopreserved duckweed plants and duckweed plant tissues, and viable duckweed plants and duckweed tissues recovered therefrom are also provided. In some embodiments, the duckweed frond colony, duckweed plant, and duckweed tissue comprise a heterologous polynucleotide of interest, which can encode a heterologous polypeptide of interest.

### FIELD OF THE INVENTION

The present invention relates to compositions and methods for cryopreserving duckweed plants.

### BACKGROUND OF THE INVENTION

More than 150 recombinantly produced proteins and polypeptides have been approved by the U.S. Food and Drug Administration (FDA) for use as biotechnology drugs and vaccines, with another 370 in clinical trials. Proteins tested to date come from both prokaryotic and eukaryotic sources and are quite varied in both structure and function.

Plants provide a convenient and economical host system in which to express high levels of recombinant proteins of pharmaceutical interest. Duckweed plants, in particular, are capable of producing high yields of transgenic proteins and are, therefore, especially useful as hosts for plant expression systems. Duckweed is the sole member of the family Lemnaceae, which is comprised of five genera and 38 species. Duckweeds are small, free-floating, fresh-water plants whose geographical range spans the entire globe (Landolt (1986) Biosystematic Investigations in the Family of Duckweeds: The Family of Lemnaceae—A Monographic Study (Geobatanischen Institut ETH, Stiftung Rubel, Zurich)). The growth habit of duckweeds makes the plant ideal for recombinant protein expression. The plant rapidly proliferates through vegetative budding of new fronds, in a macroscopic manner analogous to asexual propagation in yeast. Doubling times vary by species and are as short as 20-24 hours (Landolt (1957) Ber. Schweiz. Bot. Ges. 67:271; Chang et al. (1977) Bull. Inst. Chem. Acad. Sin. 24:19; Datko and Mudd (1970) Plant Physiol. 65:16; Venkataraman et al. (1970) Z. Pflanzenphysiol. 62: 316).

Furthermore, intensive culture of duckweed results in the highest rates of biomass accumulation per unit time (Landolt and Kandeler (1987) The Family of Lemnaceae—A Monographic Study Vol. 2: Phytochemistry, Physiology, Application, Bibliography (Veroffentlichungen des Geobotanischen Institutes ETH, Stiftung Rubel, Zurich)), with dry weight accumulation ranging from 6-15% of fresh weight (Tillberg et al. (1979) Physiol. Plant. 46:5; Landolt (1957) Ber. Schweiz. Bot. Ges. 67:271; Stomp, unpublished data). Protein content of a number of duckweed species grown under varying conditions has been reported to range from 15-45% dry weight (Chang et al. (1977) Bull. Inst. Chem. Acad. Sin. 24:19; Chang and Chui (1978) Z. Pflanzenphysiol. 89:91; Porath et al. (1979) Aquatic Botany 7:272; Appenroth et al. (1982) Biochem. Physiol. Pflanz. 177:251). Using these values, the level of protein production per liter of medium in duckweed is on the same order of magnitude as yeast gene expression systems. In comparison with yeast expression systems, plant-based expression systems have the added benefits of exhibiting post-translational processing that is similar to mammalian cells and the ability to assemble multi-subunit proteins (Hiatt (1990) Nature 334:469).

Provided herein are methods for the cryopreservation of duckweed plants and plant tissues, as well as compositions comprising cryopreserved duckweed plants and duckweed plant tissues.

### BRIEF SUMMARY OF THE INVENTION

Methods for the cryopreservation of duckweed plants and duckweed plant tissues are provided. The methods comprise freezing a dehydrated duckweed frond colony comprising more than one duckweed plant to a cryopreservative temperature to obtain a frozen frond colony comprising at least one cryopreserved duckweed plant or a cryopreserved duckweed plant tissue. The duckweed frond colony can be frozen in the presence or absence of a cryoprotective solution. In some embodiments, the duckweed frond colony is dehydrated by incubating the frond colony in a sugar solution, followed by an incubation for a period of time in a cryoprotective solution prior to freezing.

In certain embodiments, a dormancy induction step is included before or during the dehydration step, wherein the dormancy induction step comprises culturing a duckweed frond colony under dormancy-inducing conditions. In some embodiments, the method can further comprise a pretreatment step, wherein a duckweed plant is exposed to a pretreatment medium prior to the dormancy-induction step to obtain the duckweed frond colony to be frozen.

The dormancy-induction step comprises exposing the duckweed frond colony to conditions that mimic those that trigger dormancy in duckweed in its native environment. In some embodiments, the dormancy-induction step comprises exposing the frond colony to a cool temperature regime. In some of these embodiments, the dormancy-induction further comprises exposing the frond colony to a photoperiod comprising a short day and long night. In other embodiments, the dormancy-induction step is performed in the presence of a sugar solution, which in some embodiments, comprises a combination of raffinose, trehalose, sucrose, mannitol, glucose, and sorbitol.

Cryopreserved duckweed plants and duckweed plant tissues, and recovered viable duckweed plants and plant tissues are provided. In some embodiments, the duckweed frond colonies, duckweed plants, and duckweed plant tissues comprise a heterologous polynucleotide of interest. In some of these embodiments, the heterologous polynucleotide of interest encodes a heterologous polypeptide of interest.

The following embodiments are encompassed by the present invention:

1. A method for cryopreserving a duckweed plant or duckweed plant tissue, wherein said method comprises freezing a dehydrated duckweed frond colony to a cryopreservative temperature, wherein said duckweed frond colony comprises more than one duckweed plant, to obtain a frozen frond colony comprising at least one cryopreserved duckweed plant or a cryopreserved duckweed plant tissue.

2. The method of embodiment 1, wherein said duckweed plant or duckweed plant tissue is selected from the group consisting of the genus Spirodela, genus Wolffia, genus Wolffiella, genus Landoltia, and genus Lemna.

3. The method of embodiment 2, wherein said duckweed plant or duckweed plant tissue is selected from the group consisting of Lemna minor, Lemna minuta, Lemna aequinoctialis, Lemna gibba, Lemna japonica, Lemna tenera, Lemna trisulca, Lemna turionfera, Lemna valdiviana, Lemna yungensis, Wolffia cylindracea, Spirodela polyrrhiza, and Landoltia punctata.

4. The method of embodiment 1, wherein said method further comprises dehydrating a duckweed frond colony, thereby producing said dehydrated duckweed frond colony.

5. The method of embodiment 4, wherein said dehydrating comprises incubating a duckweed frond colony in a cryoprotective solution, thereby producing said dehydrated duckweed frond colony.

6. The method of embodiment 5, wherein said duckweed frond colony is incubated in said cryoprotective solution for a time period of between about 15 minutes and about 60 minutes at a temperature of between about 2° C. and about 8° C. prior to freezing.

7. The method of embodiment 6, wherein said duckweed frond colony is incubated in said cryoprotective solution for about 30 minutes at about 4° C. in the absence of light.

8. The method of any one of embodiments 5-7, wherein said cryoprotective solution comprises dimethyl sulfoxide, ethylene glycol, glycerol, propylene glycol, polyethylene glycol, butanediol, formamide, propanediol, sorbitol, mannitol, trehalose, raffinose, glucose, sucrose, zinc sulfate, magnesium sulfate, polyglycerol, polyvinyl alcohol, or mixtures thereof.

9. The method of embodiment 8, wherein said cryoprotective solution comprises dimethyl sulfoxide, ethylene glycol, glycerol, and sucrose.

10. The method of embodiment 9, wherein said cryoprotective solution comprises about 1.9 M dimethyl sulfoxide, about 2.4 M ethylene glycol, about 3.2 M glycerol, and about 0.4 M sucrose.

11. The method of any one of embodiments 4-10, wherein said method further comprises a dormancy-induction step prior to or during said dehydrating.

12. The method of embodiment 11, wherein said dormancy-induction step has a duration of between about 5 days and about 35 days.

13. The method of embodiment 12, wherein said duration is between about 7 days and about 28 days.

14. The method of embodiment 13, wherein said duration is about 28 days.

15. The method of embodiment 11, wherein said dormancy-induction step comprises culturing said duckweed frond colony under a cool temperature regime.

16. The method of embodiment 15, wherein said cool temperature regime comprises a temperature of between about 2° C. and about 25° C.

17. The method of embodiment 16, wherein said temperature is about 10° C.

18. The method of embodiment 15, wherein said duckweed frond colony is cultured in the absence of light.

19. The method of embodiment 15, wherein said dormancy-induction step further comprises culturing said duckweed frond colony under a short-day/long-night photoperiod, wherein said short-day/long-night photoperiod comprises daytime hours and nighttime hours.

20. The method of embodiment 19, wherein said daytime hours have a duration of between about 6 hours and about 14 hours.

21. The method of embodiment 20, wherein the duration of said daytime hours is about 12 hours.

22. The method of embodiment 19, wherein said duckweed frond colony is cultured under a constant temperature during daytime hours of said short-day/long-night photoperiod.

23. The method of embodiment 22, wherein said temperature during said daytime hours is between about 8° C. and 25° C.

24. The method of embodiment 23, wherein said temperature during said daytime hours is about 15° C.

25. The method of embodiment 19, wherein said duckweed frond colony is cultured under a fluctuating temperature during daytime hours of said short-day/long-night photoperiod.

26. The method of embodiment 25, wherein said temperature during said daytime hours is between about 8° C. and 25° C.

27. The method of embodiment 26, wherein said daytime hours are divided into: a first time period having a duration of between about 2 hours and about 6 hours, a second time period having a duration of between about 2 hours and about 6 hours, and a third time period having a duration of between about 2 hours and about 6 hours; wherein said temperature during said first time period is between about 8° C. and about 12° C., said temperature during said second time period is between about 12° C. and 25° C., and said temperature during third time period is between about 8° C. and about 12° C.

28. The method of embodiment 27, wherein the duration of said first time period is about 3 hours, the duration of said second time period is about 6 hours, and the duration of said third time period is about 3 hours; wherein said temperature during said first time period is about 10° C., said temperature during second time period is about 15° C., and said temperature during said third time period is about 10° C.

29. The method of any one of embodiments 19-28, wherein said duckweed frond colony is cultured under a constant temperature during nighttime hours of said short-day/long-night photoperiod.

30. The method of embodiment 29, wherein said temperature during said nighttime hours is between about 2° C. and less than 8° C.

31. The method of embodiment 30, wherein said temperature during said nighttime hours is about 4° C.

32. The method of any one of embodiments 19-28, wherein said duckweed frond colony is cultured under a fluctuating temperature during said nighttime hours of said short-day/long-night photoperiod.

33. The method of embodiment 32, wherein said temperature during said nighttime hours is between about 2° C. and less than 8° C.

34. The method of any one of embodiments 19-33, wherein said duckweed frond colony is cultured under a constant light level during daytime hours of said short-day/long-night photoperiod.

35. The method of any one of embodiments 19-33, wherein said duckweed frond colony is cultured under a fluctuating light level during daytime hours of said short-day/long-night photoperiod.

36. The method of embodiment 34 or embodiment 35, wherein said light level during daytime hours is between about 1 μM·M⁻²·sec⁻¹ and about 100 μM·M⁻²·sec⁻¹ during said daytime hours.

37. The method of embodiment 35, wherein said daytime hours are divided into: a first time period having a duration of between about 2 hours and about 6 hours, a second time period having a duration of between about 2 hours and about 6 hours, and a third time period having a duration of between about 2 hours and about 6 hours; wherein said light level during said first time period is between about 1 μM·M⁻²·sec⁻¹ and about 50 μM·M⁻²·sec⁻¹, said light level during said second time period is between about 25 μM·M⁻²·sec⁻¹ and about 100 μM·M⁻²·sec⁻¹, and said light level during said third time period is between about 1 μM·M⁻²·sec⁻¹ and about 50 μM·M⁻²·sec⁻¹, wherein the difference in said light level between said first and said second time periods and between said second and said third time periods has a value of at least 5 μM·M⁻²·sec⁻¹.

38. The method of embodiment 37, wherein the duration of said first time period is about 3 hours, the duration of said second time period is about 6 hours, and the duration of said third time period is about 3 hours; wherein said light level during said first time period is between about 25 μM·M⁻²·sec⁻¹ and about 50 μM·M⁻²·sec⁻¹, said light level during said second time period is between about 25 μM·M⁻²·sec⁻¹ and about 75 μM·M⁻²·sec⁻¹, and said light level during said third time period is between about 25 μM·M⁻²·sec⁻¹ and about 50 μM·M⁻²·sec⁻¹.

39. The method of any one of embodiments 11-38, wherein said dormancy-induction step further comprises culturing said duckweed frond colony in a sugar solution.

40. The method of embodiment 39, wherein said sugar solution comprises at least one sugar selected from the group consisting of trehalose, sucrose, sorbitol, raffinose, glucose, mannitol, and derivatives thereof.

41. The method of embodiment 39 or embodiment 40 wherein the total concentration of said sugar in said sugar solution is between about 20 mg/mL and about 270 mg/mL.

42. The method of embodiment 41, wherein said total concentration of said sugar in said sugar solution is about 90 mg/mL.

43. The method of any one of embodiments 11-42, further comprising a pretreatment step prior to the dormancy-induction step, wherein said pretreatment step comprises culturing a duckweed plant in a pretreatment medium to obtain said duckweed frond colony.

44. The method of embodiment 43, wherein said pretreatment medium comprises a sugar or a combination of sugars.

45. The method of embodiment 44, wherein said sugar or combination of sugars comprises one or more sugars selected from the group consisting of trehalose, sucrose, sorbitol, raffinose, glucose, mannitol, and derivatives thereof.

46. The method of embodiment 45, wherein said sugar is sucrose, and wherein said pretreatment medium comprises said sucrose at a concentration of about 20 mg/mL.

47. The method of any one of embodiments 43-46, wherein said duration of said pretreatment step is between about 1 day and about 1 year.

48. The method of any one of embodiments 1-47, wherein said dehydrated duckweed frond colony is in a cryoprotective solution during said freezing.

49. The method of embodiment 48, wherein said cryoprotective solution comprises dimethyl sulfoxide, ethylene glycol, glycerol, propylene glycol, polyethylene glycol, butanediol, formamide, propanediol, sorbitol, mannitol, trehalose, raffinose, glucose, sucrose, zinc sulfate, magnesium sulfate, polyglycerol, polyvinyl alcohol, or mixtures thereof.

50. The method of embodiment 49, wherein said cryoprotective solution comprises dimethyl sulfoxide, ethylene glycol, glycerol, and sucrose.

51. The method of embodiment 50, wherein said cryoprotective solution comprises about 1.92 M dimethyl sulfoxide, about 2.42 Methylene glycol, about 3.26 M glycerol, and about 0.4 M sucrose.

52. The method of any one of embodiments 1-51, wherein said dehydrated duckweed frond colony is rapidly frozen to a cryopreservative temperature.

53. The method of any one of embodiments 1-51, wherein said freezing comprises cooling said dehydrated duckweed frond colony in a slow-cooling process to said cryopreservative temperature.

54. The method of embodiment 53, wherein said slow-cooling process comprises cooling said duckweed frond colony as follows:
a) cooling to about 4° C.;
b) cooling to about −4° C. at about 1° C. per minute;
c) cooling to about −40° C. at about 25° C. per minute;
d) heating to about −12° C. at about 10° C. per minute;
e) cooling to about −40° C. at about 1° C. per minute;
f) cooling to about −90° C. at about 10° C. per minute; and
g) cooling to about −150° C. at about 10° C. per minute.

55. The method of any one of embodiments 1-54, wherein said cryopreservative temperature is less than about −140° C.

56. The method of any one of embodiments 1-55, further comprising a step of storing said frozen duckweed frond colony at a cryopreservative temperature for at least one month.

57. The method of any one of embodiments 1-55, further comprising a step of storing said frozen duckweed frond colony at a cryopreservative temperature for at least one year.

58. The method of any one of embodiments 1-57, wherein said duckweed frond colony, duckweed plant or duckweed plant tissue comprises a heterologous polynucleotide of interest.

59. The method of embodiment 58, wherein said heterologous polynucleotide encodes a heterologous polypeptide of interest.

60. The method of embodiment 59, wherein said heterologous polypeptide of interest is selected from the group consisting of insulin, growth hormone, α-interferon, β-interferon, β-glucocerebrosidase, β-glucoronidase, retinoblastoma protein, p53 protein, angiostatin, leptin, erythropoietin, granulocyte macrophage colony stimulating factor, plasminogen, microplasminogen, tissue plasminogen activator, Factor VII, Factor VIII, Factor IX, activated protein C, alpha 1-antitrypsin, monoclonal antibodies, Fab fragments, single-chain antibodies, cytokines, receptors, hormones, human vaccines, animal vaccines, peptides, and serum albumin.

61. The method of any one of embodiments 1-60, further comprising a recovery step, wherein said frozen duckweed frond colony is thawed and processed to obtain at least one recovered viable duckweed plant or duckweed plant tissue.

62. The method of embodiment 61, wherein said frozen duckweed frond colony is thawed at a temperature of between about 15° C. and about 40° C.

63. The method of embodiment 62, wherein said temperature is about 20° C.

64. The method of any one of embodiments 61-63, wherein said cryoprotective solution is removed and said frozen duckweed frond colony is exposed to a recovery medium comprising a cryoprotective agent.

65. The method of embodiment 64, wherein said cryoprotective agent in said recovery medium is a sugar or a combination of sugars.

66. The method of embodiment 65, wherein said sugar is sucrose and said recovery medium comprises said sucrose at a concentration of between about 0.5 M and about 1.5 M.

67. The method of embodiment 66, wherein said recovery medium comprises said sucrose at a concentration of about 1.2 M.

68. The method of any one of embodiments 64-67, wherein said cryoprotective agent in said recovery medium is removed from said recovery medium by a serial dilution of said recovery medium.

69. The method of any one of embodiments 61-68, wherein greater than about 50% of duckweed plants within said frozen and thawed duckweed frond colony are viable.

70. The method of embodiment 69, wherein greater than about 70% of duckweed plants within said frozen and thawed duckweed frond colony are viable.

71. The method of embodiment 70, wherein greater than about 80% of duckweed plants within said frozen and thawed duckweed frond colony are viable.

72. The method of any one of embodiments 61-71, wherein said recovered viable duckweed plant or viable duckweed plant tissue comprises a heterologous polynucleotide of interest.

73. The method of embodiment 72, wherein said heterologous polynucleotide of interest encodes a heterologous polypeptide of interest.

74. The method of embodiment 73, wherein the level of expression of said heterologous polypeptide of interest by said viable duckweed plant or viable duckweed plant tissue is at least equivalent to the level of expression of said heterologous protein by said duckweed plant prior to cryopreservation and recovery of said viable duckweed plant or viable duckweed plant tissue.

75. The method of embodiment 73, wherein the level of expression of said heterologous polypeptide of interest by said viable duckweed plant or viable duckweed plant tissue is at least 75% of the level of expression of said heterologous polypeptide by said duckweed plant prior to cryopreservation and recovery of said viable duckweed plant or viable duckweed plant tissue.

76. The method of embodiment 75, wherein the level of expression of said heterologous polypeptide of interest is at least 90% of the level of expression of said heterologous polypeptide in said duckweed plant prior to cryopreservation and recovery of said viable duckweed plant or viable duckweed plant tissue.

77. The method of any one of embodiments 73-76, wherein said heterologous polypeptide is selected from the group consisting of insulin, growth hormone, α-interferon, β-interferon, β-glucocerebrosidase, β-glucoronidase, retinoblastoma protein, p53 protein, angiostatin, leptin, erythropoietin, granulocyte macrophage colony stimulating factor, plasminogen, microplasminogen, tissue plasminogen activator, Factor VII, Factor VIII, Factor IX, activated protein C, alpha 1-antitrypsin, monoclonal antibodies, Fab fragments, single-chain antibodies, cytokines, receptors, hormones, human vaccines, animal vaccines, peptides, and serum albumin.

78. A cryopreserved duckweed plant or duckweed plant tissue cryopreserved according to the methods of any one of embodiments 1-77.

79. A cryopreserved duckweed plant or duckweed plant tissue.

80. A recovered viable duckweed plant or duckweed plant tissue obtained from said cryopreserved duckweed plant or duckweed plant tissue of embodiment 78 or embodiment 79.

81. A duckweed plant or duckweed frond colony propagated from said recovered viable duckweed plant or said recovered viable duckweed plant tissue of embodiment 80.

82. The duckweed plant or duckweed plant tissue of any one of embodiments 78-81, wherein said duckweed plant or said duckweed plant tissue is selected from the group consisting of the genus Spirodela, genus Wolffia, genus Wolffiella, genus Landoltia, and genus Lemna.

83. The duckweed plant or duckweed plant tissue of embodiment 82, wherein said duckweed plant or said duckweed plant tissue is selected from the group consisting of Lemna minor, Lemna minuta, Lemna aequinoctialis, Lemna gibba, Lemna japonica, Lemna tenera, Lemna trisulca, Lemna turionfera, Lemna valdiviana, Lemna yungensis, Wolffia cylindracea, Spirodela polyrrhiza, and Landoltia punctata.

84. The duckweed plant or duckweed plant tissue of any one of embodiments 78-83, wherein said duckweed plant or duckweed plant tissue comprises a heterologous polynucleotide of interest.

85. The duckweed plant or duckweed plant tissue of embodiment 84, wherein said heterologous polynucleotide encodes a heterologous polypeptide of interest.

86. The duckweed plant or duckweed plant tissue of embodiment 85, wherein said heterologous polypeptide of interest is selected from the group consisting of insulin, growth hormone, α-interferon, β-interferon, β-glucocerebrosidase, β-glucoronidase, retinoblastoma protein, p53 protein, angiostatin, leptin, erythropoietin, granulocyte macrophage colony stimulating factor, plasminogen, microplasminogen, tissue plasminogen activator, Factor VII, Factor VIII, Factor IX, activated protein C, alpha 1-antitrypsin, monoclonal antibodies, Fab fragments, single-chain antibodies, cytokines, receptors, hormones, human vaccines, animal vaccines, peptides, and serum albumin.

These and other aspects of the invention are disclosed in more detail in the description of the invention given below.

### BRIEF DESCRIPTION OF THE SEVERAL VIEWS OF THE DRAWING(S)

FIG. 1 shows three Lemna minor frond colonies that have been frozen and thawed according to a non-limiting embodiment of the presently disclosed methods. The tissue of the daughter frond that is enclosed within the pouch created by the flap of mother frond tissue survives the freezing process. The viable tissue is visibly green and is able to produce new daughter fronds, whereas the white tissue is senescent or non-viable.

FIGS. 2A and 2B show a Lemna minor three-frond colony of the transgenic line IFN61-B2-101, wherein a frond (F1, comprising its own F2 daughter frond) has been removed from the colony, and the F2 daughter frond has further been removed from the F1 mother frond. The F2 daughter that has been excised from the F1 mother frond was cut at the approximate midpoint and the lower section comprising the meristematic tissue is indicated by an arrow (FIG. 2B).

### DETAILED DESCRIPTION OF THE INVENTION

The ability to store transgenic duckweed plants expressing recombinant proteins or duckweed lines that are particularly amenable to transformation for an indefinite period of time would be advantageous due to their ability to express high levels of transgenic proteins. The most widely used method for long-term preservation of biological material is cryopreservation, which is based on the reduction and subsequent arrest of metabolic functions when biological materials are stored at ultra-low temperatures. At the temperature of liquid nitrogen, almost all metabolic activities in the cell cease and cells can be maintained in this suspended but viable state for extended periods of time. In contrast to serial propagation, cryopreservation of transgenic or non-transgenic plants avoids loss by contamination, minimizes genetic change, and delays aging and senescence.

Multiple methods have been described for the cryopreservation of cells and tissues of various plant species (see, for example, International Application Publication No. WO 96/39812, and U.S. Pat. Nos. 6,127,181 and 6,753,182, each of which are herein incorporated by reference in its entirety). However, aquatic plants are composed of relatively high levels of water, making cryopreservation of aquatic plant tissues difficult. Thus, cryopreservative methods aimed at preserving aquatic plant species have focused on the cryopreservation of seeds or spores of the plants (Touchell and Walters (2000) CryoLetters 21:261; Kuwano et al. (1994) Journal of Phycology 30:566; Richards et al. (2004) Conservation Genetics 5:853). Duckweed plants mainly reproduce asexually, and when seeds are produced, they are miniscule in size (Landolt (1986) Biosystematic Investigations in the Family of Duckweeds: The Family of Lemnaceae—A Monographic Study (Geobatanischen Institut ETH, Stiftung Rubel, Zurich)). Therefore, methods that allow for the cryopreservation of duckweed tissue or duckweed fronds are needed.

The methods and compositions of the invention provide for long-term storage of desirable transgenic and wild-type duckweed plants and duckweed plant tissues. Methods for the cryopreservation of duckweed plants and duckweed plant tissues comprise freezing a dehydrated duckweed frond colony to a cryopreservative temperature to obtain a frozen frond colony comprising at least one cryopreserved duckweed plant or cryopreserved duckweed plant tissue. The frozen duckweed frond colony can be thawed to obtain a recovered, viable duckweed plant or duckweed plant tissue. Cryopreserved duckweed plants and duckweed plant tissues, and viable plants and plant tissues recovered therefrom are also provided.

The term “duckweed” refers to members of the family Lemnaceae. This family is currently divided into five genera and 38 species of duckweed as follows: genus Lemna (L. aequinoctialis, L. disperma, L. ecuadoriensis, L. gibba, L. japonica, L. minor, L. miniscula (also known as L. minuta), L. obscura, L. perpusilla, L. tenera, L. trisulca, L. turionifera, L. valdiviana, L. yungensis); genus Spirodela (S. intermedia, S. polyrrhiza); genus Wolffia (Wa. angusta, Wa. arrhiza, Wa. australina, Wa. borealis, Wa. brasiliensis, Wa. columbiana, Wa. cylindracea, Wa. elongata, Wa. globosa, Wa. microscopica, Wa. neglecta); genus Wolffiella (Wl. caudata, Wl. denticulata, Wl. gladiata, Wl. hyalina, Wl. lingulata, Wl. neotropica, Wl. oblonga, Wl. repunda, Wl. rotunda, and Wl. welwitschii) and genus Landoltia (La. punctata). Any other genera or species of Lemnaceae, if they exist, are also aspects of the present invention. Lemna species can be classified using the taxonomic scheme described by Landolt (1986) Biosystematic Investigations in the Family of Duckweeds: The Family of Lemnaceae—A Monographic Study (Geobatanischen Institut ETH, Stiftung Rubel, Zurich).

By “duckweed plant tissue” is intended a group of similar cells within a duckweed plant that perform a similar function or have a similar phenotype. A “duckweed plant” refers to duckweed tissue comprising at least one frond. A frond is a developmental hybrid of leaf and stem origin and can refer to a mother or a daughter frond. New fronds (i.e., daughter fronds) arise from meristematic tissue found on the ventral surface of the frond (referred to as the mother frond) through vegetative budding. Meristematic cells lie in two pockets, one on each side of the frond midvein, from which fronds alternately bud. The pockets comprising the meristematic tissue are protected by a tissue flap of the mother frond, which creates a pouch in which the meristematic zone is found. The small midvein region is also the site from which the root originates and the strip of tissue called a stipule or stipe arises that connects each daughter frond to its mother frond. See, for example, Landolt (1957) Ber. Schweiz. Bot. Ges. 67:271; Chang et al. (1977) Bull. Inst. Chem. Acad. Sin. 24:19; Datko and Mudd (1970) Plant Physiol. 65:16; Venkataraman et al. (1970) Z. Pflanzenphysiol. 62:316. A “duckweed frond colony” comprises at least one mother frond with at least one daughter frond attached thereto. Data presented elsewhere herein indicates that the daughter frond and meristematic region require protection by the tissue flap of the mother frond during cryopreservative procedures to allow cryopreservation of the duckweed tissue and recovery therefrom. Thus, the methods of the invention require the starting material for cryopreservation to comprise at least one daughter frond attached to at least one mother frond.

The present invention involves culturing duckweed plants in a medium. By “culturing in a medium” is intended the process of growing a duckweed plant or duckweed frond colony whereby the plant material is placed in the vicinity of the medium wherein at least one component of the medium is able to enter the tissue. In some embodiments, the duckweed plant or frond colony is cultured by placing the tissue in direct contact with a solid, semisolid, or liquid medium. When duckweed plants or frond colonies are cultured in liquid medium, the vessel containing the culture media and plant may be, but need not be, shaken. In some embodiments, the medium will be a liquid medium. In other embodiments, the duckweed plants or duckweed frond colonies will be grown on a solid or semisolid medium. Solid duckweed culture media additionally comprise a solidifying agent such as, for example, agar.

The methods of the invention do not depend on a particular duckweed culture media. Any suitable duckweed culture medium known in the art may be employed in the methods of the present invention. These include such basal salt mixtures that are known in the art, including, but not limited to, Schenk and Hildebrandt, Hoagland's E-Medium, Cleland and Briggs formulation of Hoagland's Medium, Hutner's solution, and the like. Generally, the pH of the plant culture media of the invention will fall within the range of about 3.5 to about 10.5, including, for example, about 3.5, about 4.0, about 4.5, about 5.0, about 5.5, about 6.0, about 6.5, about 7.0, about 7.5, about 8.0, about 8.5, about 9.0, about 9.5, about 10.0, about 10.5, and other such pH values between about 3.5 and about 10.5. In some embodiments, the media will have a pH of about 4 to about 7. In some of these embodiments, the media will have a pH of about 5.6.

It is also recognized that the duckweed plants that are cultured in a particular media may be routinely transferred to fresh duckweed culture media when necessary. Such routine transfers of plant tissue to fresh plant culture media are known in the art.

The present invention allows for the cryopreservation and long-term storage of duckweed plants or plant tissues. By “cryopreservation” is intended a process of cooling and storing biological materials at cryopreservative temperatures, which are temperatures at which the metabolic activity of the biological material is reduced or arrested, in a manner that allows for the recovery of the biological material once thawed. In some embodiments, a cryopreservative temperature is a temperature equal to or less than −140° C., which is the temperature at which most biological processes are substantially inhibited. Successful cryopreservation techniques effect cell dehydration and concentration of the cytosol in a controlled and minimally injurious manner so that ice crystallization in the cytosol is precluded or minimized during the freezing process. The addition of cryoprotective agents, which aid in dehydration and reduce ice crystal formation, and culturing techniques that serve to reduce the metabolic rate and increase the intracellular concentration of solutes help protect the plant from injury. By “cryopreserved” in the context of duckweed plants or plant tissues is intended duckweed plant material that has been frozen at cryopreservative temperatures and is capable of being recovered. By “recovered” in the context of duckweed plants or plant tissues is intended frozen duckweed plant material that has been thawed to temperatures favorable for normal metabolic function and is capable of growth and propagation.

In accordance with the methods of the present invention, cryopreservation of duckweed plants or duckweed plant tissues is accomplished by freezing a dehydrated duckweed frond colony to a cryopreservative temperature. The dehydrated duckweed frond colony can be frozen in the absence or presence of a cryoprotective solution. By “cryoprotective solution” is intended a solution comprising at least one cryoprotective agent present in an amount sufficient to protect the plant cells during freezing and to allow recovery of a viable plant or plant tissue. By “viable” in the context of a duckweed plant or duckweed tissue is intended a plant or tissue that is metabolically active and is capable of growth and/or propagation. Viability can easily be assessed by any method known in the art. A “cryoprotectant” or “cryoprotective agent” is any agent that protects the duckweed plant or duckweed plant tissue from injury during the freezing process. Generally, a cryoprotectant is any additive that can be provided to a biological material before and/or during freezing that yields a higher post-thaw recovery than can be obtained in its absence. The cryoprotective solution serves to dehydrate the plant tissue, reduce intracellular ice formation, and provide protection against injury during the freezing or thawing process to enhance the recovery rate of viable plants and plant tissues.

The cryoprotective solution can comprise any cryoprotective agent known to one of skill in the art, including cryoprotective agents that are able to permeate across the cell membrane and enter the cell as well as those that are non-permeating. It should be noted that the ability of a cryoprotective agent to permeate the cell membrane will depend on a number of factors, including temperature and the cellular membrane size, which may vary by cell type or by duckweed plant genus or species. In some embodiments, the cryoprotective solution comprises at least one permeating cryoprotectant. Permeating cryoprotectants are believed to function by colligative action, reducing the intracellular water concentration and decreasing ice formation. Examples of permeating cryoprotective agents that can be used for the present invention include, but are not limited to, dimethyl sulfoxide (DMSO), ethylene glycol, glycerol, propylene glycol, polyethylene glycol, butanediol, formamide, and propanediol. In other embodiments, the cryoprotective solution comprises at least one non-permeating cryoprotectant. In yet other embodiments, the cryoprotective solution comprises at least one permeating cryoprotectant and at least one non-permeating cryoprotectant. Non-permeating cryoprotectants include those that function as osmotic agents, drawing water out of the cell and concentrating the cytosol. Examples of non-permeating cryoprotective agents that can be added to the cryoprotective solution include, but are not limited to, sugars, such as trehalose, sucrose, sorbitol, raffinose, glucose, and mannitol. In addition, some non-permeating and permeating agents function by protecting the cell membrane from damage. It will be appreciated that other suitable cryoprotectants may be employed consistent with the objectives of the present invention.

The cryoprotective solution lowers the water content and concentrates the cytosol in the cells of the duckweed plant tissues within the duckweed frond colony and avoids excessive intracellular ice crystal formation during freezing and any subsequent thawing, which protects against cell death due to disruption of cellular membranes and organelles. If the cytosol of the cells within a plant tissue is sufficiently concentrated, the cytosol will vitrify during the freezing process, avoiding ice formation. By “vitrify” or “vitrification” is intended the act of transforming, or the transformation of, a liquid into a non-crystalline amorphous phase, a glass. A properly vitrified cell forms a transparent frozen amorphous solid consisting of ice crystals too small to diffract light. If a vitrified cell is allowed to warm to about −40° C., it may undergo devitrification. In devitrification, ice crystals enlarge and consolidate in a process which is generally detrimental to cell survival. Cryoprotective solutions serve to enhance vitrification of cells upon freezing and retard devitrification upon thawing.

When the frond colony is frozen in the cryoprotective solution or any other type of freezing medium, ice blockers, such as polyvinyl alcohol polymers or polyglycerol, or a combination thereof (such as Super cool X-1000™ and Super cool Z-1000™ available from 21^{st} Century Medicine, Fontana, Calif.) can be added to the cryoprotective solution to decrease the nucleation of ice crystals or to slow their growth, contributing to vitrification. Further, divalent cations, including but not limited to, magnesium sulfate, zinc sulfate, magnesium chloride, calcium chloride, and manganese chloride, can be added to the cryoprotective solution. Divalent cations serve to reduce freezing temperatures and to reduce intracellular and intercellular ice crystal formation during freezing and thawing. Divalent cations also stabilize membrane proteins and cellular membranes.

In some embodiments, the cryoprotective solution comprises DMSO, ethylene glycol, glycerol, and sucrose. In some of these embodiments, the concentration of DMSO is between about 0.1 M and about 5 M, including but not limited to about 0.1 M, about 0.5 M, about 1 M, about 1.5 M, about 2 M, about 2.5 M, about 3 M, about 3.5 M, about 4 M, about 4.5 M, about 5 M, and any other concentration between about 0.1 M and about 5 M. In certain embodiments, the concentration of DMSO in the cryoprotective solution is about 1.92 M. In some embodiments, the concentration of ethylene glycol in the cryoprotective solution is between about 0.1 M and about 5 M, including but not limited to about 0.1 M, about 0.5 M, about 1 M, about 1.5 M, about 2 M, about 2.5 M, about 3 M, about 3.5 M, about 4 M, about 4.5 M, about 5 M, and any other concentration between about 0.1 M and about 5 M. In certain embodiments, the concentration of ethylene glycol in the cryoprotective solution is about 2.42 M. In particular embodiments, the concentration of glycerol in the cryoprotective solution is between about 0.1 M and about 5 M, including but not limited to about 0.1 M, about 0.5 M, about 1 M, about 1.5 M, about 2 M, about 2.5 M, about 3 M, about 3.5 M, about 4 M, about 4.5 M, about 5 M, and any other concentration between about 0.1 M and about 5 M. In certain embodiments, the concentration of glycerol in the cryoprotective solution is about 3.26 M. In some embodiments, the concentration of sucrose in the cryoprotective solution is between about 0.1 M and about 5 M, including but not limited to about 0.1 M, about 0.5 M, about 1 M, about 1.5 M, about 2 M, about 2.5 M, about 3 M, about 3.5 M, about 4 M, about 4.5 M, about 5 M, and any other concentration between about 0.1 M and about 5 M. In certain embodiments, the concentration of sucrose in the cryoprotective solution is about 0.4 M.

In certain embodiments, the pH of the cryoprotective solution is between about 3.5 and about 10.5, including but not limited to about 3.5, about 4.0, about 4.5, about 5.0, about 5.5, about 6.0, about 6.5, about 7.0, about 7.5, about 8.0, about 8.5, about 9.0, about 9.5, about 10.0, about 10.5, and any other pH between about 3.5 and about 10.5. In particular embodiments, the pH of the cryoprotective solution is about 5.8. In some of the embodiments wherein the pH of the cryoprotective solution is about 5.8, the cryoprotective solution comprises about 1.92 M DMSO, about 2.42 ethylene glycol, about 3.26 glycerol, and about 0.4 M sucrose.

In some embodiments, the duckweed frond colony is incubated in the cryoprotective solution for a period of time prior to freezing to cryopreservative temperatures. In some embodiments, the time period of incubation in the cryoprotective solution has a duration of between about 1 minute and about 10 hours, including, for example, about 1 minute, about 2 minutes, about 5 minutes, about 10 minutes, about 15 minutes, about 30 minutes, about 45 minutes, about 1 hour, about 2 hours, about 2.5 hours, about 3 hours, about 3.5 hours, about 4 hours, about 4.5 hours, about 5 hours, about 5.5 hours, about 6 hours, about 6.5 hours, about 7 hours, about 7.5 hours, about 8 hours, about 9 hours, about 9.5 hours, about 10 hours, and any other such duration between about 1 minute and about 10 hours. This incubation can be performed at an aerial temperature of between about 2° C. and about 40° C., including, for example, about 2° C., about 3° C., about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., about 25° C., about 30° C., about 35° C., about 40° C., and any other such temperature between about 2° C. and about 40° C., and can be performed in the absence or presence of light. In some embodiments, the temperature is between about 2° C. and about 8° C. In certain embodiments, the duckweed frond colony is incubated for about 30 minutes in the cryoprotective solution at an aerial temperature of about 4° C. in the dark. In particular embodiments, the cryoprotective solution is replaced with fresh cryoprotective solution following this incubation period prior to freezing the duckweed frond colony. As described elsewhere herein, this incubation in the cryoprotective solution can serve to dehydrate a frond colony.

The dehydrated duckweed frond colony can be frozen in the presence or absence of a cryoprotective solution to obtain a frozen frond colony. By “freezing” or “freeze” is intended a process by which the duckweed frond colony is cooled, and passes from a liquid to a solid state. The term “freezing” also encompasses vitrifying, wherein the duckweed frond colony forms a glasslike, amorphous solid state, substantially free of ice crystals. A “frozen” duckweed frond colony has undergone the process of freezing. Any suitable freezing method known in the art can be used to freeze the duckweed frond colony.

Generally, two main freezing methods are used for the cryopreservation of biological materials, either a slow and controlled freezing process or a rapid freezing process. Slow freezing methods occur in a step-wise manner and allow for additional dehydration of the biological sample. Given the relatively high water content of duckweed due to their aquatic nature, a slow freezing protocol may be preferred for some species of duckweed to further dehydrate the tissue. Therefore, in some embodiments, the duckweed frond colony is frozen with a slow-cooling process. By “slow-cooling process” is intended a method whereby the duckweed frond colony is brought to the desired cryopreservation temperature by subjecting the biological sample to temperatures that are decreased incrementally. In one such embodiment, the slow-cooling process comprises the following steps: cooling the duckweed frond colony to about 4° C., lowering the temperature to about −4° C. at about 1.0° C. per minute, lowering the temperature to about −40° C. at about 25.0° C. per minute, raising the temperature to about −12° C. at about 10.0° C. per minute, lowering the temperature to about −40° C. at about 1.0° C. per minute, lowering the temperature to about −90° C. at about 10.0° C. per minute, and lowering the temperature to about −150° C. at about 10.0° C. per minute, followed by transfer of the duckweed frond colony to the vapor phase of liquid nitrogen.

In other embodiments, the dehydrated duckweed frond colony is frozen rapidly. In some of these embodiments, the duckweed frond colony is frozen to cryopreservative temperatures in the absence of any solution. Rapid freezing and thawing steps help to reduce ice crystal damage. Generally, the higher the water content of the tissue to be frozen, the faster the tissue must be frozen and thawed to minimize the ice crystal damage to the cells of the tissue. In these embodiments, the dehydrated duckweed frond colony can be transferred to a vial or other vessel and the vessel can be plunged into liquid nitrogen to effect rapid freezing.

According to the presently disclosed methods, a dehydrated duckweed frond colony is frozen to a cryopreservative temperature. As used herein, a “dehydrated duckweed frond colony” is one that has a reduced amount of water in comparison to a control duckweed frond colony. A control duckweed frond colony can be the same duckweed frond colony prior to dehydration. Alternatively, the control duckweed frond colony can be a duckweed frond colony that is similar to the dehydrated duckweed frond colony (e.g., at a similar growth stage, similar phenotype, same strain or species) cultured under growth conditions (e.g., medium, light, temperature) that are normally used for its growth or a similar duckweed frond colony found in nature under average environmental conditions conducive to its growth. A dehydrated duckweed frond colony can exhibit a reduction in water weight in comparison to a control duckweed frond colony in a range of about 1% to about 99% or greater, including but not limited to, about 1%, about 2%, about 3%, about 4%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 96%, about 97%, about 98%, about 99%, or greater reduction in water weight in comparison to a control duckweed frond colony.

The dehydrated frond colony can be dehydrated by any means known in the art including but not limited to, vacuum evaporation, exposure to the air current of a laminar flow cabinet, exposure to a stream of compressed air, incubation in an airtight container with silica gel or the like, incubation with various osmotic agents, such as non-permeating cryoprotectants (e.g., sugars). In some embodiments, the frond colony is dehydrated via incubation in the same cryoprotective solution used during the freezing step of the presently disclosed methods over a period of time, as described above. In some of these embodiments, following the incubation, the cryoprotective solution is replaced with fresh cryoprotective solution prior to freezing.

In particular embodiments, the duckweed frond colony is cultured in a sugar solution in order to dehydrate the frond colony. By “sugar solution” is intended a medium (solid, semisolid, or liquid) comprising at least one sugar (the term “sugar” encompasses monosaccharides, disaccharides, trisaccharides, or other polysaccharides, as well as sugar derivatives, such as sugar alcohols). In addition to aiding in dehydration of the duckweed tissue, sugars help to stabilize and protect the cell membrane from damage during the freezing process. In some of these embodiments, the sugar(s) are selected from the group consisting of trehalose, sucrose, sorbitol, raffinose, glucose, mannitol, and derivatives thereof. In some embodiments, the sugar solution comprises a combination of all of the aforementioned sugars. In other embodiments, the sugar solution comprises mannitol, sorbitol, or a combination thereof. In still other embodiments, the sugar solution comprises raffinose, trehalose, sucrose or a combination thereof. In some of these embodiments, the sugar solution does not comprise sorbitol, mannitol, or glucose.

The concentration of sugars in the sugar solution is high enough to result in dehydration of a duckweed frond colony incubated therein. In certain embodiments, the total concentration of sugars in the medium is between about 20 mg/mL (weight/volume; w/v) and about 400 mg/mL (w/v), including but not limited to, about 20 mg/mL, about 30 mg/mL, about 40 mg/mL, about 50 mg/mL, about 60 mg/mL, about 70 mg/mL, about 80 mg/mL, about 90 mg/mL, about 100 mg/mL, about 150 mg/mL, about 200 mg/mL, about 250 mg/mL, about 300 mg/mL, about 350 mg/mL, about 400 mg/mL, and any other concentration between about 20 mg/mL and about 400 mg/mL. In certain embodiments, the total concentration of sugars in the medium is between about 20 mg/mL (w/v) and about 270 mg/mL (w/v). In particular embodiments, the total concentration of sugars in the medium is about 90 mg/mL. In other embodiments, the sugar solution comprises sucrose at a concentration of 20 mg/ml (w/v).

Multiple methods can be used to dehydrate a duckweed frond colony. For example, in some embodiments, duckweed frond colonies are incubated in a sugar solution, followed by an incubation in the cryoprotective solution prior to freezing.

Dehydration can occur in a gradual or stepwise manner. Exposure to the components of a cryoprotective solution or a sugar solution, for example, can be gradual with continuously increasing amounts of the components of the solution added to the frond colony or can be stepwise wherein increasing amounts are added over a set period of time. Likewise, each component or combinations of components of the cryoprotective solution, sugar solution, or other type of solution used for dehydrating can be added in a stepwise manner to the frond colony. Gradual or stepwise addition of the components of the cryoprotective solution or dehydration solution (e.g., sugar solution) serves to acclimate the frond colony to the cryoprotective or dehydration solution. A solution comprising fewer than all the components of a dehydration solution or cryoprotective solution is referred to herein as a pretreatment medium and is described elsewhere herein.

Alternatively, in some embodiments, the duckweed frond colony can be prepared for cryopreservation by an encapsulation-dehydration method, wherein a duckweed frond colony is dehydrated (e.g., through the incubation of the duckweed frond colony in a sugar solution), followed by the encapsulation of the dehydrated duckweed frond colony in calcium alginate beads. The dehydrated frond colonies are encapsulated through the incubation of the frond colonies in a solution comprising alginate. In some embodiments, the concentration of alginate in the solution is between about 0.1% (weight/volume; w/v) and about 20% (w/v), including but not limited to about 0.1%, about 0.5%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20% (w/v), and any other concentration between about 0.1% and about 20%. In particular embodiments, the concentration of alginate in the solution is between about 1% (w/v) and about 10% (w/v). In certain embodiments, the dehydrated duckweed frond colony is incubated in a solution comprising about 2% alginate.

Following the encapsulation with alginate, the beads can be hardened by incubating the encapsulated duckweed frond colony in a solution comprising calcium chloride. The calcium chloride can be at a concentration of between about 0.01 M and about 10 M, including but not limited to about 0.01 M, about 0.05 M, about 0.1 M, about 0.5 M, about 1 M, about 2 M, about 3 M, about 4 M, about 5 M, about 6 M, about 7 M, about 8 M, about 9 M, about 10 M, and any other concentration between about 0.01 M and about 10 M. In certain embodiments, the encapsulated frond colony is incubated in a solution comprising about 0.1 M calcium chloride. The encapsulated duckweed frond colony can be incubated in the calcium chloride solution for a period of time having a duration ranging from about 15 minutes to about 120 minutes, including but not limited to about 15 minutes, about 20 minutes, about 30 minutes, about 40 minutes, about 50 minutes, about 60 minutes, about 70 minutes, about 80 minutes, about 90 minutes, about 100 minutes, about 110 minutes, about 120 minutes, and any such duration between about 15 minutes and about 120 minutes. In certain embodiments, the alginate-encapsulated duckweed frond colony is incubated in a calcium chloride solution for a period of time ranging from about 60 minutes to about 90 minutes.

A duckweed frond colony can also be encapsulated by alginate beads prior to dehydration of the frond colony. In this embodiment, the frond colony can be encapsulated as described above, followed by an incubation in a calcium chloride solution to harden the beads. Once the beads are hardened, the encapsulated frond colony can be dehydrated through exposure of the beads to the air current of a laminar flow cabinet, exposure to a stream of compressed air, or an incubation in an airtight container with silica gel or the like.

Prior to or during the dehydration of the duckweed frond colony, the frond colony can be cultured under dormancy-inducing conditions. By “dormancy-inducing conditions” is intended those conditions that mimic native environmental conditions known to trigger dormancy in duckweed. By “dormancy” is intended a temporary, quiescent state of biological rest or inactivity. It is recognized that for the present invention, it is not required that the duckweed plants within the frond colony actually enter a state of dormancy. The dormancy-induction step only mimics environmental conditions known to trigger dormancy when a duckweed plant is grown in its native environment. In nature, duckweed plants enter a dormant or resting state during unfavorable growth conditions, forming resting fronds, turions, or turion-like structures. Turions or turion-like structures contain higher levels of starch and fewer air spaces, allowing the fronds to sink and become submerged in the silt found at the bottom of bodies of water. Cold temperatures, in particular, increase intracellular levels of sugars, which aid in the stabilization of the plasma membrane. Prolonged exposure to reduced temperatures leads to changes in the lipid composition of the plasma membrane, providing further protection from freeze-induced injury. These intracellular changes combined with submersion in the waterbed help the plant to survive through unfavorable conditions, particularly low temperatures (Landolt (1986) Biosystematic Investigations in the Family of Duckweeds: The Family of Lemnaceae—A Monographic Study (Geobatanischen Institut ETH, Stiftung Rubel, Zurich)). While not being bound by any theory or mechanism of action, it is believed that exposure of the duckweed plants to conditions that mimic those that trigger dormancy in the native environment stimulate the fronds to store concentrated levels of starches and sugars, minimize metabolic activity, decrease their water content, and alter the composition of lipids in the plasma membranes of the cells of the plant, allowing the fronds to survive under unfavorable conditions, including low temperatures.

Factors known to trigger dormancy in duckweed plants that may be used in the present invention include, but are not limited to the following: incubation in sucrose, abscisic acid, low temperatures, shortage of nutrients, and shortened day lengths (Landolt (1986) Biosystematic Investigations in the Family of Duckweeds: The Family of Lemnaceae—A Monographic Study (Geobatanischen Institut ETH, Stiftung Rubel, Zurich), which is herein incorporated by reference in its entirety).

In some embodiments, the dormancy-induction step has a duration of between about 5 days and about 35 days, including, for example, about 5 days, about 6 days, about 7 days, about 8 days, about 9 days, about 10 days, about 11 days, about 12 days, about 13 days, about 14 days, about 15 days, about 16 days, about 17 day, about 18 days, about 19 days, about 20 days, about 21 days, about 22 days, about 23 days, about 24 days, about 25 days, about 26 days, about 27 days, about 28 days, about 29 days, about 30 days, about 31 days, about 32 days, about 33 days, about 34 days, about 35 days, and any other such duration between about 5 days and about 35 days.

In some embodiments, one or more duckweed frond colonies are cultured under a cool temperature regime during the dormancy-induction step. By “cool temperature regime” is intended an aerial temperature of between about 2° C. and about 25° C., including, for example, about 2° C., about 3° C., about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., about 25° C., and any other such temperature of between about 2° C. and about 25° C. It is recognized that the minimum and maximum cool temperature during the dormancy-induction step that is necessary to allow recovery of a viable duckweed plant or duckweed plant tissue from a frozen duckweed frond colony may vary between duckweed species. However, the minimum and maximum cool temperature can be determined for any given species of duckweed plant using the methods disclosed herein.

Incubation of the duckweed frond colony at temperatures that are reduced from normal culturing temperatures prepares the cells for the cryopreservation process by significantly retarding cellular metabolism and reducing the shock of rapid temperature transitions through some of the more critical temperature changes. Critical temperature ranges are those ranges at which there is the highest risk of cell damage, for example, around the critical temperatures of ice crystal formation. Acclimation to cold temperatures results in the accumulation of endogenous solutes that decreases the extent of cell dehydration at any given osmotic potential, and contributes to the stabilization of proteins and membranes during extreme dehydration. In addition, cold adaptation interacts synergistically with cryoprotectants and results in alterations in the liquid conformation of the cellular membranes, increasing tolerance to dehydration.

The cool temperature regime during the dormancy-induction step can consist of a constant temperature or fluctuating temperatures. By “constant” in the context of an environmental condition, such as temperature or light level, it is intended that the condition is unchanging or invariable. It is recognized that, due to limitations associated with any technological device that can be used to regulate a particular environmental condition, there will be some variation in the environmental condition in those embodiments wherein a technological device is used. Therefore, it is understood that the term “constant” is defined as unchanging or invariable, but can incorporate the inherent deviations associated with the technological device that is responsible for controlling a particular condition.

By “fluctuating” in the context of an environmental condition, such as temperature or light level, it is intended that the condition is variable. In those embodiments wherein a technological device is responsible for controlling the environmental condition, a fluctuating environmental condition is variable to a degree that is greater than the inherent deviation associated with the technological device.

In some embodiments, the duckweed frond colony is cultured under a constant cool temperature, regardless of the light exposure (i.e. cultured under the same temperature during both daytime and nighttime hours). In other embodiments, the cool temperature fluctuates between about 2° C. and about 25° C.

In certain embodiments, the dormancy-induction step comprises culturing the duckweed frond colonies under a cool temperature regime in the absence of light. In other embodiments, the frond colonies undergo a cool temperature regime and are cultured under a short day/long night photoperiod. The dormancy-induction step can also comprise culturing the duckweed frond colony under a short day/long night photoperiod under normal growth temperatures.

By “photoperiod” is intended a recurring cycle of light (“daytime”) and dark (“nighttime”) periods. By “day,” “daylight hours,” or “daytime” is intended the period during which the duckweed frond colony is exposed to light of any intensity. Conversely, by “night,” “nighttime,” or “nighttime hours” is intended the period during which the duckweed frond colony is cultured in darkness and is not exposed to a direct light source. By “short-day/long-night photoperiod” is intended a recurring cycle of light and dark periods that comprises daytime hours having a duration of between about 6 hours and about 14 hours, including, for example, about 6 hours, about 6.5 hours, about 7 hours, about 7.5 hours, about 8 hours, about 8.5 hours, about 9 hours, about 9.5 hours, about 10 hours, about 10.5 hours, about 11 hours, about 11.5 hours, about 12 hours, about 12.5 hours, about 13 hours, about 13.5 hours, about 14 hours, and other such durations between about 6 hours and about 14 hours. In some embodiments, the daytime hours have a duration of about 12 hours. In other embodiments, the daytime hours have a duration of about 9 hours. In some embodiments, the photoperiod comprises a 24-hour cycle, wherein the nighttime hours have a duration of between 10 hours and about 18 hours, including for example, about 10 hours, about 11 hours, about 12 hours, about 13 hours, about 14 hours, about 15 hours, about 16 hours, about 17 hours, about 18 hours, and any other such durations between about 10 hours and about 18 hours.

In some of these embodiments, the cool temperature is held constant during daytime hours and held constant during nighttime hours, but the daytime temperature and nighttime temperature are different. In these embodiments, it is recognized that the daytime temperature will always be higher than the nighttime temperature. In some of these embodiments, the temperature during daytime hours is between about 8° C. and about 25° C., including, for example, about 8° C., about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., about 25° C., and other such temperatures between about 8° C. and about 25° C. In some of these embodiments, the temperature during the nighttime hours is about 2° C. and less than about 8° C., including, for example, about 2° C., about 2.5° C., about 3° C., about 3.5° C., about 4° C., about 4.5° C., about 5° C., about 5.5° C., about 6° C., about 6.5° C., about 7° C., about 7.5° C., and other such temperatures between about 2° C. and less than about 8° C. In some of these embodiments, the incubation temperature during nighttime hours is about 4° C.

In still other embodiments, the cool temperature fluctuates during daytime hours, and is held constant during nighttime hours. In these embodiments, it is recognized that the minimum daytime temperature will always be higher than the nighttime temperature. In some of these embodiments, the temperature during the daytime hours fluctuates between a minimum of about 8° C. and a maximum of about 25° C. It is recognized that the fluctuation in temperature can be represented by incremental increases and decreases in temperature, such that the temperature at the beginning of the daytime hours is about 8° C., increases in a step-wise manner to a maximum of about 25° C., and then decreases in a step-wise manner back to about 8° C. by the end of the daytime hours. Such incremental changes in temperature can be accomplished using any of the well known technological devices known to those of skill in the art, and can be programmed such that the peak temperature occurs at a desired time point during the daytime hours of any given short-day/long-night photoperiod. In some embodiments, the peak temperature occurs approximately half-way through the duration of the daytime hours. Thus, for example, where the daytime hours have a duration of about 12 hours, the fluctuation in temperature can be programmed such that the peak temperature of about 25° C. occurs about 6 hours into the daytime portion of the short-day/long-night photoperiod.

In some of these embodiments, the daytime hours during the dormancy-induction step are divided into three time periods, with the first time period having a duration of between about 2 hours and about 6 hours; the second time period having a duration of between about 2 hours and about 6 hours; and the third time period having a duration of between about 2 hours and about 6 hours. In these embodiments, the duration of the first, second, and third time periods can vary between about 2 hours and about 6 hours, including, for example, about 2 hours, about 2.5 hours, about 3 hours, about 3.5 hours, about 4 hours, about 4.5 hours, about 5 hours, about 5.5 hours, about 6 hours, and other such durations between about 2 hours and about 6 hours. In this manner, the duckweed frond colony can be exposed to fluctuating temperatures over the course of daytime hours, having a total duration of about 6 hours to about 14 hours out of the short-day/long-night photoperiod. In some embodiments, the temperature during the first time period is between about 8° C. and about 12° C., including, for example, about 8° C., about 8.5° C., about 9° C., about 9.5° C., about 10° C., about 10.5° C., about 11° C., about 11.5° C., about 12° C., and any other such temperature between about 8° C. and about 12° C.; the temperature during the second time period is between about 12° C. and about 25° C., including, for example, about 12° C., about 13° C., about 14° C., about 15° C., about 16° C., about 17° C., about 18° C., about 19° C., about 20° C., about 21° C., about 22° C., about 23° C., about 24° C., about 25° C., and any other such temperature between about 12° C. and about 25° C.; and the temperature during the third time period is between about 8° C. and about 12° C., including, for example, about 8° C., about 8.5° C., about 9° C., about 9.5° C., about 10° C., about 10.5° C., about 11° C., about 11.5° C., about 12° C., and any other such temperature between about 8° C. and about 12° C.

In one such embodiment, the temperature during daytime hours fluctuates and the duckweed frond colony is exposed to a temperature of about 10° C. for about 3 hours, followed by an incubation at about 15° C. for about 6 hours and an incubation at about 10° C. for about 3 hours.

In yet other embodiments, the cool temperature regime during the dormancy-induction step comprises a constant temperature during the daytime hours and a fluctuating temperature during the nighttime hours. In these embodiments, the daytime temperature is always higher than the maximum nighttime temperature. In still other embodiments, the temperature fluctuates during the daytime hours and during the nighttime hours and the minimum temperature during the daytime hours will always be higher than the maximum temperature during the nighttime hours.

In some embodiments, during the dormancy-induction step, the duckweed frond colony is cultured under a constant light level during daytime hours of the short-day/long-night photoperiod. By “light level” is intended the intensity of the light source to which the plants are exposed, which can be measured in μM·M⁻²·sec⁻¹. In some of these embodiments, the light level is between about 1 μM·M⁻²·sec⁻¹ and about 100 μM·M⁻²·sec⁻¹ during daytime hours, including, for example, about 1 μM·M⁻²·sec⁻¹, about 5 μM·M⁻²·sec⁻¹, about 10 μM·M⁻²·sec⁻¹, about 15 μM·M⁻²·sec⁻¹, about 20 μM·M⁻²·sec⁻¹, about 25 μM·M⁻²·sec⁻¹, about 30 μM·M⁻²M⁻²·sec⁻¹, about 35 μM·M⁻²·sec⁻¹, about 40 μM·M⁻²·sec⁻¹, about 45 μM·M⁻²·sec⁻¹, about 50 μM·M⁻²·sec⁻¹, about 55 μM·M⁻²·sec⁻¹, about 60 μM·M⁻²·sec⁻¹, about 65 μM·M⁻²·sec⁻¹, about 70 μM·M⁻²·sec⁻¹, about 75 μM·M⁻²·sec⁻¹, about 80 μM·M⁻²·sec⁻¹, about 85 μM·M⁻²·sec⁻¹, about 90 μM·M⁻²·sec⁻¹, about 95 μM·M⁻²·sec⁻¹, about 100 μM·M⁻²·sec⁻¹, and other such levels between about 1 μM·M⁻²·sec⁻¹ and about 100 μM·M⁻²·sec⁻¹.

In other embodiments, the duckweed frond colony is cultured under a fluctuating light level during daytime hours of the dormancy-induction step. In some of these embodiments, the light intensity during the daytime hours fluctuates between a minimum of about 1 μM·M⁻²·sec⁻¹ and a maximum of about 100 μM·M⁻²·sec⁻¹. It is recognized that the fluctuation in light level can be represented by incremental increases and decreases in light level. For example, the light level at the beginning of the daytime hours can be about 25 μM·M⁻²·sec⁻¹, and can increase in a step-wise manner to a maximum of about 100 μM·M⁻²·sec⁻¹, and then decrease in a step-wise manner back to about 25 μM·M⁻²·sec⁻¹ by the end of the daytime hours. Such incremental changes in light intensity can be accomplished using any of the well known technological devices known to those of skill in the art, and can be programmed such that the peak light intensity occurs at a desired time point during the daytime hours of any given short-day/long-night photoperiod. In some embodiments, the peak light intensity occurs approximately half-way through the duration of the daytime hours. Thus, for example, where the daytime hours have a duration of about 12 hours, the fluctuation in light intensity can be programmed such that the peak light intensity of about 100 μM·M⁻²·sec⁻¹ occurs about 6 hours into the daytime portion of the short-day/long-night photoperiod.

In some embodiments, the daytime hours during the dormancy-induction step are divided into three time periods, with the first time period having a duration of between about 2 hours and about 6 hours; the second time period having a duration of between about 2 hours and about 6 hours; and the third time period having a duration of between about 2 hours and about 6 hours. In these embodiments, the duration of the first, second, and third time periods can vary between about 2 hours and about 6 hours, including, for example, about 2 hours, about 2.5 hours, about 3 hours, about 3.5 hours, about 4 hours, about 4.5 hours, about 5 hours, about 5.5 hours, about 6 hours, and other such durations between about 2 hours and about 6 hours. In this manner, the duckweed frond colony can be exposed to fluctuating light levels over the course of daytime hours, having a total duration of about 6 hours to about 14 hours out of the short-day/long-night photoperiod. In some embodiments, the light level during the first time period is between about 1 μM·M⁻²·sec⁻¹ and about 50 μM·M⁻²·sec⁻¹, including, for example, about 1 μM·M⁻²·sec⁻¹, about 5 μM·M⁻²·sec⁻¹, about 10 μM·M⁻²·sec⁻¹, about 15 μM·M⁻²·sec⁻¹, about 20 μM·M⁻²·sec⁻¹, about 25 μM·M⁻²·sec⁻¹, about 30 μM·M⁻²·sec⁻¹, about 35 μM·M⁻²·sec⁻¹, about 40 μM·M⁻²·sec⁻¹, about 45 μM·M⁻²·sec⁻¹, about 50 μM·M⁻²·sec⁻¹, and any other such level between about 1 μM·M⁻²·sec⁻¹ and about 50 μM·M⁻²·sec⁻¹; the light level during the second time period is between about 25 μM·M⁻²·sec⁻¹ and about 100 μM·M⁻²·sec⁻¹, including, for example, about 25 μM·M⁻²·sec⁻¹, about 30 μM·M⁻²·sec⁻¹, about 35 μM·M⁻²·sec⁻¹, about 40 μM·M⁻²·sec⁻¹, about 45 μM·M⁻²·sec⁻¹, about 50 μM·M⁻²·sec⁻¹, about 55 μM·M⁻²·sec⁻¹, about 60 μM·M⁻²·sec⁻¹, about 65 μM·M⁻²·sec⁻¹, about 70 μM·M⁻²·sec⁻¹, about 75 μM·M⁻²·sec⁻¹, about 80 μM·M⁻²·sec⁻¹, about 85 μM·M⁻²·sec⁻¹, about 90 μM·M⁻²·sec⁻¹, about 95 μM·M⁻²·sec⁻¹, about 100 μM·M⁻²·sec⁻¹, and any other such light level between about 25 μM·M⁻²·sec⁻¹ and about 100 μM·M⁻²·sec⁻¹; and the light level during the third time period is between about 1 μM·M⁻²·sec⁻¹ and about 50 μM·M⁻²·sec⁻¹, including, for example, about 1 μM·M⁻²·sec⁻¹, about 5 μM·M⁻²·sec⁻¹, about 10 μM·M⁻²·sec⁻¹, about 15 μM·M⁻²·sec⁻¹, about 20 μM·M⁻²·sec⁻¹, about 25 μM·M⁻²·sec⁻¹, about 30 μM·M⁻²·sec⁻¹, about 35 μM·M⁻²·sec⁻¹, about 40 μM·M⁻²·sec⁻¹, about 45 μM·M⁻²·sec⁻¹, about 50 μM·M⁻²·sec⁻¹, and any other such level between about 1 μM·M⁻²·sec⁻¹ and about 50 μM·M⁻²·sec⁻¹. In some of these embodiments, the difference in the light level between the first and the second time periods and between the second and the third time periods has a value of at least about 5 μM·M⁻²·sec⁻¹. Generally, in these embodiments, the light level between the first and second time periods increases by a value of at least about 5 μM·M⁻²·sec⁻¹ and the light level between the second and third time periods decreases by a value of at least about 5 μM·M⁻²·sec⁻¹.

In one such embodiment, the light level during daytime hours fluctuates and the duckweed frond colony is exposed to a light level of between about 25 μM·M⁻²·sec⁻¹ and about 50 μM·M⁻²·sec⁻¹ for about 3 hours, followed by a light level of between about 25 μM·M⁻²·sec⁻¹ and about 75 μM·M⁻²·sec⁻¹ for about 6 hours, and a light level of between about 25 μM·M⁻²·sec⁻¹ and about 50 μM·M⁻²·sec⁻¹ for about 3 hours.

In some embodiments, the dormancy-induction step comprises culturing the duckweed frond colony at fluctuating temperatures and light levels during the daytime hours. In some of these embodiments, the frond colony is cultured at an aerial temperature of about 10° C. and a light level of between about 25 μM·M⁻²·sec⁻¹ and about 50 μM·M⁻²·sec⁻¹ for a duration of about 3 hours, followed by an aerial temperature of about 15° C. and a light level of between about 25 μM·M⁻²·sec⁻¹ and about 75 μM·M⁻²·sec⁻¹ for a duration of about 6 hours, and then an aerial temperature of about 10° C. and a light level of between about 25 μM·M⁻²·sec⁻¹ and about 50 μM·M⁻²·sec⁻¹ for a duration of about 3 hours. In these embodiments, the duckweed frond colony is cultured at a constant temperature of about 4° C. in the absence of light during the nighttime hours, which comprise a duration of about 12 hours.

In particular embodiments, the duckweed frond colony is cultured in a sugar solution as described elsewhere herein during the dormancy-induction step.

The cryopreservative methods of the present invention can optionally comprise performing a pretreatment step prior to the dormancy-induction step and/or the dehydration step. By “pretreatment step” is intended a period of culturing at least one duckweed plant in a pretreatment medium in order to obtain the duckweed frond colony for dehydration and cryopreservation. By “pretreatment medium” is intended culture medium (solid, semisolid, or liquid) comprising at least one component that is present in the solution during the dehydration step or in the cryoprotective solution or culture medium comprising one or all of the components that are present in the solution during the dehydration step or in the cryoprotective solution at a lower concentration than the concentration of these components within the dehydration solution or the cryoprotective solution. In some embodiments, the pretreatment medium comprises at least one sugar that is present in the sugar solution during the dehydration step. In some embodiments, the pretreatment medium comprises a fewer number of sugars than the sugar solution used in the dehydration step. In other embodiments, the pretreatment medium comprises the same sugars as the sugar solution used in the dehydration step, with at least one of these sugars being present at a lower concentration than that within the sugar solution.

While not being bound by any theory or mechanism of action, it is believed that pretreatment of a duckweed plant in a pretreatment medium helps to acclimate the plant to the solution used during the dehydration step or the cryoprotective solution. In those embodiments wherein the pretreatment medium comprises at least one sugar that is present in the sugar solution during the dehydration step, the sugar or combination of sugars can be selected from the group consisting of trehalose, sucrose, sorbitol, raffinose, glucose, mannitol, and derivatives thereof. In some of these embodiments, the pretreatment medium comprises sucrose at a concentration of about 20 mg/mL (w/v).

In some embodiments, the pretreatment step has a duration of between about 1 day and about 5 years, including, for example, about 1 day, about 5 days, about 10 days, about 15 days, about 20 days, about 25 days, about 30 days, about 1 month, about 1.5 months, about 2 months, about 3 months, about 4 months, about 5 months, about 6 months, about 7 months, about 8 months, about 9 months, about 10 months, about 11 months, about 1 year, about 1.5 years, about 2 years, about 3 years, about 4 years, about 5 years, and other such durations of between about 1 day and about 5 years. Some embodiments comprise a pretreatment step having a duration of about 30 days, while others comprise a pretreatment step having a duration of about 45 days or about 1.5 months, and yet others comprise a pretreatment step having a duration of about 1 day to about 1 year.

In some embodiments, the pretreatment step is performed at an aerial temperature of between about 15° C. and about 40° C., including for example, about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., about 40° C., and any other such temperature between about 15° C. and about 40° C. In certain embodiments, the aerial temperature during the pretreatment step is between about 21° C. and about 30° C. During the pretreatment step, the light level can be between about 1 μM·M⁻²·sec⁻¹ and about 450 μM·M⁻²·sec⁻¹, including for example about 1 μM·M⁻²·sec⁻¹, about 5 μM·M⁻²·sec⁻¹, about 10 μM·M⁻²·sec⁻¹, about 20 μM·M⁻²·sec⁻¹, about 30 μM·M⁻²·sec⁻¹, about 40 μM·M⁻²·sec⁻¹, about 50 μM·M⁻²·sec⁻¹, about 60 μM·M⁻²·sec⁻¹, about 70 μM·M⁻²·sec⁻¹, about 80 μM·M⁻²·sec⁻¹, about 90 μM·M⁻²·sec⁻¹, about 100 μM·M⁻²·sec⁻¹, about 150 μM·M⁻²·sec⁻¹, about 200 μM·M⁻²·sec⁻¹, about 250 μM·M⁻²·sec⁻¹, about 300 μM·M⁻²·sec⁻¹, about 400 μM·M⁻²·sec⁻¹, about 450 μM·M⁻²·sec⁻¹, and any other such level between about 1 μM·M⁻²·sec⁻¹ and about 450 μM·M⁻²·sec⁻¹.

In some embodiments, stabilizers such as antioxidants and radical scavenger chemicals that neutralize the effects attributable to the presence of reactive oxygen species (ROS) and other free radicals, can be added to the pretreatment medium, sugar solution or other solution used to dehydrate the duckweed frond colony, or both. ROS and other free radicals are capable of damaging cellular membranes, both internal and external membranes, such that cryopreservation and recovery are seriously compromised. Useful stabilizers include but are not limited to reduced glutathione, 1,1,3,3-tetramethylurea, 1,1,3,3-tetramethyl-2-thiourea, sodium thiosulfate, silver thiosulfate, betaine, N,N-dimethylformamide, N-(2-mercaptopropionyl) glycine, β-mercaptoethylamine, selenomethionine, thiourea, propylgallate, dimercaptopropanol, ascorbic acid, cysteine, sodium diethyl dithiocarbomate, spermine, spermidine, ferulic acid, sesamol, resorcinol, propylgallate, MDL-71,897, cadaverine, putrescine, 1,3- and 1,2-diaminopropane, deoxyglucose, uric acid, salicylic acid, 3- and 4-amino-1,2,4-triazol, benzoic acid, hydroxylamine, and combinations and derivatives thereof. Similarly, divalent cations, including but not limited to, magnesium sulfate, zinc sulfate, magnesium chloride, calcium chloride, and manganese chloride, can be added to the pretreatment medium, sugar solution (or other solution used to dehydrate the duckweed frond colony), or the cryoprotective solution as described elsewhere herein.

Abscisic acid can be used during the dormancy-induction step, can be added to the pretreatment medium, and in some embodiments, can be added to the sugar solution or other type of solution used to dehydrate the duckweed frond colony, to the cryoprotective solution, or both.

Frozen duckweed frond colonies can be stored at a cryopreservative temperature (e.g., about −140° C. or lower) for as long a period of time as needed. In some embodiments, the frozen duckweed frond colony is stored in liquid nitrogen. In some of these embodiments, the duckweed frond colony is stored in the liquid phase of liquid nitrogen and in other embodiments, the duckweed frond colony is stored in the vapor phase of liquid nitrogen. In some embodiments, the duckweed frond colony is stored in liquid nitrogen for at least about one month, about six months, about one year, about two years, about 5 years, about 10 years, about 20 years, or longer.

The frozen duckweed frond colony can be subjected to a recovery step at any desired point in time in order to obtain recovered viable duckweed plants and plant tissues that are metabolically active and capable of growth and propagation. In this manner, the cryopreservation methods of the present invention can be supplemented with a recovery step. By “recovery” is intended the act of thawing the frozen duckweed frond colony by incubating this plant material at temperatures favorable for normal metabolic function, and processing the thawed plant material to obtain at least one viable duckweed plant and/or viable duckweed plant tissue. For purposes of the present invention, “processing” in the context of this recovery step is intended to mean further treatment of the thawed plant material to remove cryoprotective agents from the cytosol of the cells of the plant material and to dilute any cryoprotective solution that may be localized to intercellular regions of the thawed plant material. Such treatment is also referred to as “unloading.”

In some embodiments, the frozen duckweed frond colony is thawed at a temperature of between about 15° C. and about 40° C., including, for example, about 15° C., about 20° C., about 25° C., about 30° C., about 35° C., about 40° C., and any other such temperature between about 15° C. and about 40° C. In some of these embodiments, the temperature is about 20° C.

Dilution of the cryoprotective solution and removal of the cryoprotective agents from the cells should be performed as quickly as possible subsequent to thawing of the frozen duckweed frond colony. However, the rapid removal of some cryoprotective and osmotic agents may increase cell stress and death; and thus it is recognized that in some embodiments, this removal is implemented gradually. The removal rate may be controlled by serial washing of the thawed plant material with solutions that contain fewer cryoprotective agents and/or a lower total concentration of these agents than those in the cryoprotective solution. A step-wise dilution in a hypertonic medium is also effective. In some embodiments of the present invention, the cryoprotective solution is removed immediately after thawing of the sample and replaced with an aqueous recovery medium comprising a culture medium and a cryoprotective agent or combination of cryoprotective agents. In some of these embodiments, the cryoprotective agent in the recovery medium is a sugar or a combination of sugars. The sugar can be sucrose present at a concentration of between about 0.5 M and about 1.5 M, including, for example, about 0.5 M, about 0.6 M, about 0.7 M, about 0.8 M, about 0.9 M, about 1.0 M, about 1.1 M, about 1.2 M, about 1.3 M, about 1.4 M, about 1.5 M, and any other such concentration between about 0.5 M and about 1.5 M. In one such embodiment, the cryoprotective agent in the recovery medium is sucrose at a concentration of about 1.2 M.

Removal of the cryoprotective agents from the recovery medium can be accomplished gradually through serial dilutions of the recovery medium with a medium containing little or none of the cryoprotective agent(s). Thus, for example, where the recovery medium is a 1.2 M sucrose solution, the recovery medium can be diluted via five serial dilutions, wherein half of the volume of the 1.2 M sucrose solution is removed and replaced with a medium comprising sucrose at a concentration of about 0.058 M.

Following removal of the recovery medium, the thawed duckweed frond colony can then be cultured and viability of the recovered plants and plant tissues can be assessed through any method known in the art. In some embodiments, the thawed duckweed frond colony is cultured on medium, supplemented with about 10 mg/ml sucrose and about 10 mg/ml agar at an aerial temperature of between about 15° C. and about 40° C., including, for example, about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., about 40° C., and any other temperature between about 15° C. and about 40° C., and a light level between about 20 μM·M⁻²·sec⁻¹ and about 450 μM·M⁻²·sec⁻¹, including, for example, about 20 μM·M⁻²·sec⁻¹, about 30 μM·M⁻²·sec⁻¹, about 40 μM·M⁻²·sec⁻¹, about 50 μM·M⁻²·sec⁻¹, about 60 μM·M⁻²·sec⁻¹, about 70 μM·M⁻²·sec⁻¹, about 80 μM·M⁻²·sec⁻¹, about 90 μM·M⁻²·sec⁻¹, about 100 μM·M⁻²·sec⁻¹, about 150 μM·M⁻²·sec⁻¹, about 200 μM·M⁻²·sec⁻¹, about 250 μM·M⁻²·sec⁻¹, about 300 μM·M⁻²·sec⁻¹, about 350 μM·M⁻²·sec⁻¹, about 400 μM·M⁻²·sec⁻¹, about 450 μM·M⁻²·sec⁻¹, and any other such light level between about 20 μM·M⁻²·sec⁻¹ and about 450 μM·M⁻²·sec⁻¹.

Alternatively, in other embodiments, following removal of the recovery medium, the thawed duckweed frond colony can be cultured in a liquid culture medium at optimum culture conditions for the particular duckweed species to allow outgrowth of the plant.

In certain embodiments, the viability of the recovered duckweed frond colony can be assessed following about 7 to about 14 days of culturing the thawed duckweed frond colony. In some of these embodiments, at least about 1% to about 100% of the duckweed plants within the recovered duckweed frond colony are viable or have viable duckweed plant tissue, including but not limited to at least about 5%, at least about 10%, at least about 20%, at least about 30%, at least about 40%, at least about 50%, at least about 60%, at least about 70%, at least about 80%, at least about 90%, or at least about 95%, about 100%, or any other percentage between about 1% and about 100%.

The present invention provides cryopreserved duckweed plants and duckweed plant tissues that can be held in their frozen state indefinitely until that point in time at which recovered viable duckweed plants and duckweed plant tissues are needed. In addition, the present invention provides recovered viable duckweed plants or duckweed plant tissues obtained from cryopreserved duckweed plants or duckweed plant tissues, as well as duckweed plants or frond colonies propagated from these recovered viable duckweed plants or plant tissues. The cryopreserved and recovered duckweed plants and duckweed plant tissues can be of wild-type origin, and can represent genetic lines that have one or more desirable genotypic and/or phenotypic characteristics. Thus, in some embodiments, the cryopreserved and recovered duckweed plants and duckweed plant tissues represent genetic lines that yield high transformation efficiency, exhibit rapid growth rates, rapid propagation rates, and the like.

In other embodiments, the cryopreserved and recovered duckweed plants and duckweed plant tissues are transgenic, and thus comprise one or more heterologous polynucleotide of interest, as noted herein below. In some embodiments, the cryopreserved and recovered duckweed plants and duckweed plant tissues represent transgenic lines that have one or more desirable genotypic and/or phenotypic characteristics, including, but not limited to, those noted herein above. In one such embodiment, the desirable characteristic is high expression of one or more heterologous proteins encoded by one or more heterologous polynucleotide of interest.

The transgenic duckweed plants of the invention can comprise any heterologous polynucleotide of interest. By “heterologous polynucleotide of interest” is intended a polynucleotide that originates from a foreign source, for example, a polynucleotide of artificial origin, or from a foreign species, or if from the same species, is substantially modified from its native form in composition and/or genomic locus by deliberate human intervention.

The use of the term “polynucleotide of interest” is not intended to limit the present invention to polynucleotides comprising DNA. Those of ordinary skill in the art will recognize that polynucleotides can comprise polymers of ribonucleotides and combinations of ribonucleotides and deoxyribonucleotides. Such deoxyribonucleotides and ribonucleotides include both naturally occurring molecules and synthetic analogues. The polynucleotides of the invention also encompass all forms of sequences including, but not limited to, single-stranded forms, double-stranded forms, hairpins, stem-and-loop structures, and the like.

In some embodiments, the polynucleotide of interest encodes a heterologous polypeptide intended for expression in duckweed plants. “Polypeptide” refers to any monomeric or multimeric protein or peptide comprised of a polymer of amino acid residues. The term applies to amino acid polymers in which one or more amino acid residues is an artificial chemical analogue of a corresponding naturally occurring amino acid, as well as to naturally occurring amino acid polymers. As used herein, the terms “encoding” or “encoded” when used in the context of a specified nucleic acid mean that the nucleic acid comprises the requisite information to direct translation of the nucleotide sequence into a specified protein. The information by which a protein is encoded is specified by the use of codons. A nucleic acid encoding a protein may comprise non-translated sequences (e.g., introns) within translated regions of the nucleic acid or may lack such intervening non-translated sequences (e.g., as in cDNA).

By “heterologous polypeptide of interest” is intended a polypeptide that originates from a foreign species or if from the same species, is substantially modified from its native form in composition by deliberate human intervention.

In some embodiments, the heterologous polypeptide is selected from, but not limited to, the group consisting of insulin, growth hormone, α-interferon, β-interferon, β-glucocerebrosidase, β-glucoronidase, retinoblastoma protein, p53 protein, angiostatin, leptin, erythropoietin, granulocyte macrophage colony stimulating factor, plasminogen, microplasminogen, tissue plasminogen activator, Factor VII, Factor VIII, Factor IX, activated protein C, alpha 1-antitrypsin, monoclonal antibodies, Fab fragments, single-chain antibodies, cytokines, receptors, hormones, human vaccines, animal vaccines, peptides, and serum albumin.

In other embodiments, the heterologous polynucleotide of interest is a polynucleotide comprising or encoding an “inhibitory sequence.” The term “inhibitory sequence” encompasses any polynucleotide or polypeptide sequence that is capable of inhibiting the expression of a target gene product, for example, at the level of transcription or translation, or which is capable of inhibiting the function of a target gene product. Examples of inhibitory sequences include, but are not limited to, full-length polynucleotide or polypeptide sequences, truncated polynucleotide or polypeptide sequences, fragments of polynucleotide or polypeptide sequences, variants of polynucleotide or polypeptide sequences, sense-oriented nucleotide sequences, antisense-oriented nucleotide sequences, the complement of a sense- or antisense-oriented nucleotide sequence, inverted regions of nucleotide sequences, hairpins of nucleotide sequences, double-stranded nucleotide sequences, single-stranded nucleotide sequences, combinations thereof, and the like.

It is recognized that inhibitory polynucleotides include nucleotide sequences that directly (i.e., do not require transcription) or indirectly (i.e., require transcription or transcription and translation) inhibit expression of a target gene product. For example, an inhibitory polynucleotide can comprise a nucleotide sequence that is a chemically synthesized or in vitro-produced small interfering RNA (siRNA) or micro RNA (miRNA) that, when introduced into a plant cell, tissue, or organ, would directly, though transiently, silence expression of the target gene product of interest. Alternatively, an inhibitory polynucleotide can comprise a nucleotide sequence that encodes an inhibitory nucleotide molecule that is designed to silence the expression of the gene product of interest, such as sense-orientation RNA, antisense RNA, double-stranded RNA (dsRNA), hairpin RNA (hpRNA), intron-containing hpRNA, catalytic RNA, miRNA, and the like. In yet other embodiments, the inhibitory polynucleotide can comprise a nucleotide sequence that encodes a mRNA, the translation of which yields a polypeptide that inhibits expression or function of the target gene product of interest. In this manner, where the inhibitory polynucleotide comprises a nucleotide sequence that encodes an inhibitory nucleotide molecule or a mRNA for a polypeptide, the encoding sequence is operably linked to a promoter that drives expression in a plant cell so that the encoded inhibitory nucleotide molecule or mRNA can be expressed.

The cryopreserved and recovered duckweed plants and duckweed plant tissues can be transgenic for one or more heterologous polynucleotides of interest. These heterologous polynucleotides are introduced into the duckweed plant or duckweed plant tissue, separately or together, using any acceptable method known in the art, as noted herein below. For example, a transgenic duckweed plant or duckweed plant tissue comprising one or more desired heterologous polynucleotides can be used as the target to introduce further heterologous polynucleotides by subsequent transformation, and the resulting transgenic duckweed plant or transgenic duckweed plant tissue can be cryopreserved and recovered using the methods of the present invention. The heterologous polynucleotides of interest can be introduced simultaneously in a co-transformation protocol with the polynucleotides of interest provided by any combination of transformation cassettes. For example, if two polynucleotides are introduced, the two polynucleotides can be contained in separate transformation cassettes (trans) or contained on the same transformation cassette (cis). Expression of the introduced polynucleotides can be driven by the same promoter or by different promoters. In certain cases, it may be desirable to introduce a transformation cassette that comprises an inhibitory sequence to allow for suppression of the expression of an endogenous polynucleotide of interest. This may be combined with any combination of other transformation cassettes to generate the desired combination of traits in the transgenic duckweed plant or duckweed plant tissue.

For example, where the duckweed plant or duckweed plant tissue is transgenic for production of a mammalian glycoprotein of interest, it may be desirable to further genetically modify the duckweed plant or duckweed plant tissue to alter its glycosylation machinery such that the expressed mammalian glycoprotein has a “humanized” N-glycosylation pattern. Thus, in some embodiments, the cryopreserved and recovered duckweed plants and duckweed plant tissues comprise one or more polynucleotides that provide for expression of a mammalian glycoprotein of interest and suppression of expression of α1,3-fucosyltransferase (FucT) and β1,2-xylosyltransferase (XylT). Methods for producing such transgenic duckweed plants and duckweed plant tissues are described in commonly owned International Application Nos. PCT/US2007/060642 and PCT/US2007/060646, filed Jan. 17, 2007, and published as WO 2007/084922 and WO 2007/084926, respectfully, and in corresponding U.S. patent application Ser. Nos. 11/624,164 and 11/624,158, respectively, filed Jan. 17, 2007; herein incorporated by reference in their entireties.

The polynucleotide of interest can be introduced into the duckweed plant of the invention using any method known to those of skill in the art. The term “introducing” in the context of a polynucleotide, for example, a nucleotide construct of interest, is intended to mean presenting to the plant the polynucleotide in such a manner that the polynucleotide gains access to the interior of a cell of the plant.

The methods and compositions of the invention do not depend on a particular method for introducing one or more polynucleotides into a plant, only that the polynucleotide(s) gains access to the interior of at least one cell of the plant. Methods for introducing polynucleotides into plants are known in the art including, but not limited to, transient transformation methods, stable transformation methods, and virus-mediated methods. “Transient transformation” in the context of a polynucleotide is intended to mean that a polynucleotide is introduced into the plant and does not integrate into the genome of the plant. By “stably introducing,” “stably introduced,” “stable transformation,” or “stably transformed” in the context of a polynucleotide introduced into a plant is intended the introduced polynucleotide is stably incorporated into the plant genome, and is capable of being inherited by the progeny thereof, more particularly, by the progeny of multiple successive generations. In some embodiments, successive generations include progeny produced vegetatively (i.e., asexual reproduction), for example, with clonal propagation, which is the most common form of reproduction in duckweed plants. In other embodiments, successive generations include progeny produced via sexual reproduction.

Any transformation method known in the art may be used to obtain a transgenic duckweed plant that comprises one or more polynucleotide of interest. In one embodiment, stably transformed duckweed is obtained by one of the gene transfer methods disclosed in U.S. Pat. No. 6,040,498 to Stomp et al., or U.S. Pat. No. 7,161,064 to Stomp et al.; herein incorporated by reference. The methods described in these references include gene transfer by ballistic bombardment with microprojectiles coated with a nucleic acid comprising the nucleotide sequence of interest (also know as biolistic bombardment, microprojectile bombardment, or microparticle bombardment), gene transfer by electroporation, and gene transfer mediated by Agrobacterium comprising a vector comprising the polynucleotide sequence of interest. The selection and regeneration of transgenic duckweed lines are described in these references. In one embodiment, the stably transformed duckweed is obtained via any one of the Agrobacterium-mediated methods disclosed in U.S. Pat. No. 6,040,498 to Stomp et al. or in U.S. Pat. No. 7,176,352 to Edelman et al.; herein incorporated by reference. For some of these embodiments, the Agrobacterium used is Agrobacterium tumefaciens or Agrobacterium rhizogenes. In another embodiment, the duckweed culture is transformed using PEG-mediated transformation. See, for example, Lazerri (1995) Methods Mol. Biol. 49:95-106, Mathur et al. (1998) Methods Mol. Biol. 82:267-276, and Datta et al. (1999) Methods Mol. Biol. 111:335-347; herein incorporated by reference.

In some embodiments, stably transformed duckweed are obtained by transformation with a polynucleotide of interest contained within an expression cassette. In these embodiments, the polynucleotide of interest is operably linked to expression control elements in an expression cassette. The expression cassette can further comprise one or more genes that encode selectable markers. “Operably linked” as used herein in reference to nucleotide sequences refers to multiple nucleotide sequences that are placed in a functional relationship with each other. Generally, operably linked DNA sequences are contiguous and, where necessary to join two protein coding regions, in reading frame. By “expression control element” is intended a regulatory region of DNA, usually comprising a TATA box, capable of directing RNA polymerase II, or in some embodiments, RNA polymerase III, to initiate RNA synthesis at the appropriate transcription initiation site for a particular coding sequence. An expression control element may additionally comprise other recognition sequences generally positioned upstream or 5′ to the TATA box, which influence (e.g., enhance) the transcription initiation rate. Furthermore, an expression control element may additionally comprise sequences generally positioned downstream or 3′ to the TATA box, which influence (e.g., enhance) the transcription initiation rate.

The transcription initiation region (e.g., a promoter) may be native or homologous or foreign or heterologous to the host, or could be the natural sequence or a synthetic sequence. By “foreign,” it is intended that the transcription initiation region is not found in the wild-type host into which the transcription initiation region is introduced. By “functional promoter” is intended the promoter, when operably linked to a sequence encoding a protein of interest, is capable of driving expression (i.e., transcription and translation) of the encoded protein, or, when operably linked to an inhibitory sequence encoding an inhibitory nucleotide molecule (for example, a hairpin RNA, double-stranded RNA, miRNA polynucleotide, and the like), the promoter is capable of initiating transcription (or transcription and translation) of the operably linked inhibitory sequence such that the inhibitory nucleotide molecule is expressed. The promoters can be selected based on the desired outcome. Thus the expression cassettes of the invention can comprise constitutive, inducible, tissue-preferred, or other promoters for expression in plants. Any suitable promoter known in the art can be employed according to the present invention, including bacterial, yeast, fungal, insect, mammalian, and plant promoters. For example, plant promoters, including duckweed promoters, may be used.

Examples of expression control elements, promoters and selectable marker genes suitable for use in the present invention can be found in U.S. Pat. No. 6,815,184 to Stomp et al. and U.S. Patent Applications Publication Nos. 2006-0195946, 2007-0128162, 2005-0262592, 2004-0261148, International Patent Application Publication No. WO 2005/035767, International Patent Application No. PCT/US2007/060614, Attorney Docket No. 040989/322154, filed Jan. 17, 2007, entitled “Expression Control Elements from the Lemnaceae Family,” published as WO 2007/084926, International Patent Application No. PCT/US2007/060646, and corresponding U.S. patent application Ser. No. 11/624,158, Attorney Docket No. 040989/322367, concurrently filed Jan. 17, 2007, entitled “Compositions and Methods for Humanization of N-Glycans in Plants,” and International Patent Application No. PCT/US2007/060642, published as WO 2007/084922, and corresponding U.S. patent application Ser. No. 11/624,164, Attorney Docket No. 040989/322382, concurrently filed Jan. 17, 2007, also entitled “Compositions and Methods for Humanization of N-Glycans in Plants,” the contents of each of which are herein incorporated by reference in its entirety.

It is preferred that the stably transformed duckweed plants utilized in these methods exhibit normal morphology. Preferably, transformed plants of the present invention contain a single copy of the transferred nucleic acids, and the transferred nucleic acids have no notable rearrangements therein. Also preferred are duckweed plants in which the transferred nucleic acids is present in low copy numbers (i.e., no more than five copies, alternately, no more than three copies, as a further alternative, fewer than three copies of the nucleic acid per transformed cell).

In order to assess the expression of the polynucleotide of interest or polypeptide of interest, recovered fronds can be cultured to obtain logarithmic growth. In some embodiments, this involves culturing the fronds in liquid Schenk and Hildebrandt media 1.2 (photosynthetic media) for at least two, two week transfers.

If the transgenic plant line secretes the heterologous protein into the media, samples of the media will be collected to determine the concentration of the heterologous protein. For those heterologous proteins that are not secreted, tissue samples are collected and extracts are prepared to assess the level of heterologous protein expression. The expression of the heterologous polypeptide by the recovered duckweed plants or duckweed plant tissues can be assessed using any method known to one of skill in the art, including but not limited to Western blots and enzyme-linked immunosorbent assays (ELISA). Alternatively, tissue samples can be collected and processed to obtain and analyze genomic DNA or RNA for the presence and/or expression of a heterologous polynucleotide. Any method known in the art can be used to detect the presence and/or expression of the heterologous polynucleotide within the tissue sample, including but not limited to, polymerase chain reaction (PCR), quantitative PCR, Northern blot, and Southern blot.

In some embodiments, recovered cryopreserved transgenic duckweed plants and duckweed plant tissues express the heterologous polypeptide of interest at a level equivalent to the plant prior to cryopreservation. In some of these embodiments, the expression of the polypeptide by the recovered cryopreserved plant or plant tissue is at least 50%, at least 55%, at least 60%, at least 70%, at least 75%, at least 80%, at least 85%, at least 90%, or at least 95%, of the expression level prior to cryopreservation. In other embodiments, the expression of the polypeptide by the recovered plant or plant tissue is equivalent to the expression by the plant prior to cryopreservation.

The terms “a,” “an,” and “the” refer to “one or more” when used in this application, including the claims. Thus, for example, reference to “a sample” includes a plurality of samples, unless the context clearly is to the contrary (e.g., a plurality of samples), and so forth.

Throughout this specification and the claims, the words “comprise,” “comprises,” and “comprising” are used in a non-exclusive sense, except where the context requires otherwise.

As used herein, the term “about,” when referring to a value is meant to encompass variations of, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the presently disclosed subject matter be limited to the specific values recited when defining a range.

The following examples are offered for purposes of illustration, not by way of limitation.

### EXPERIMENTAL

The following examples demonstrate the cryopreservation and recovery of multiple species of plants within the duckweed family as well as transgenic duckweed lines expressing heterologous polypeptides.

### Example 1

### Cryopreservation of the Duckweed Species Lemna Minor

Lemna minor duckweed plants were cultured on Schenk and Hildebrandt media with 20 mg/ml sucrose at an aerial temperature of between 21° C. and 30° C. and light levels ranging from 200 μM·M⁻²·sec⁻¹ to 450 μM·M⁻²·sec⁻¹ for 1 day up to 1 year. Three frond colonies (each frond colony comprised one or more daughter fronds attached to the mother frond) were aseptically transferred into a 2.0-mL cryovial containing a 900 μL solution of Schenk and Hildebrandt media, supplemented with 15 mg/ml of each D-trehalose dihydrate, sucrose, D-sorbitol, D-raffinose pentahydrate, D-glucose, and D-mannitol for the dormancy-induction step. The frond colonies were incubated in this sugar solution for 21-30 days. Each 24-hour photoperiod was comprised of fluctuations in temperature and light levels. Specifically, the daytime hours consisted of culturing the duckweed frond colony at an aerial temperature of 10° C. with a light level of about 25 μM·M⁻²·sec⁻¹ to about 50 μM·M⁻²·sec⁻¹ for a duration of 3 hours, followed by an aerial temperature of 15° C. at a light level of about 25 μM·M⁻²·sec⁻¹ to about 75 μM·M⁻²·sec⁻¹ for a duration of 6 hours, and an aerial temperature of 10° C. with a light level of about 25 μM⁻²·sec⁻¹ to about 50 μM·M⁻²·sec⁻¹ for a duration of 3 hours. During the nighttime hours of the 24-hour photoperiod, the duckweed frond colonies were cultured at an aerial temperature of 4° C. in the absence of light for a duration of 12 hours.

The duckweed frond colonies were dehydrated in a laminar flow hood in 900 μL of a cryoprotective solution, comprising 1.92 M DMSO, 2.42 Methylene glycol, 3.26 M glycerol, and 0.4 M sucrose at pH 5.8. The cryovials were incubated in this solution at 4° C. for 30 minutes to 2 hours in the absence of light. Following the incubation, the cryoprotective solution was removed and replaced with 900 μL of fresh cryoprotective solution.

The duckweed frond colonies were frozen in a slow rate freezer according to the following freezing protocol. The cryovials containing the duckweed frond colonies were held at 4° C. and the temperature was lowered to −4° C. at 1° C. per minute, to −40° C. at 25° C. per minute, and then raised to −12° C. at 10° C. per minute. The temperature was again lowered to −40° C. at 1° C. per minute, to −90° C. at 10° C. per minute, and then lowered to −150° C. at 10° C. per minute. Once frozen, the vials containing the frond colonies were transferred to the vapor phase of liquid nitrogen for storage.

After up to 17 months in storage, the frozen duckweed frond colonies were thawed and recovered as follows. The vials containing the frozen duckweed frond colonies were transferred from the liquid nitrogen storage tank to a laminar flow hood and were thawed at room temperature for approximately ten minutes. The cryoprotective solution was removed and replaced with 900 μL of Schenk and Hildebrandt medium, supplemented with 1.2 M sucrose, followed by a ten minute incubation at room temperature. The 1.2 M sucrose was subsequently diluted by a series of five dilutions whereby 450 μL of the 1.2 M sucrose solution was removed and replaced with 450 μL of Schenk and Hildebrandt medium supplemented with 20 mg/ml sucrose. Following the serial dilutions, the frond colonies were transferred to a petri dish with Schenk and Hildebrandt medium, supplemented with 10 mg/ml sucrose and 1% (weight/volume) agar. The duckweed frond colonies were cultured at an aerial temperature of between 21° C. and 30° C. with light levels ranging from about 20 μM·M⁻²·sec⁻¹ to about 100 μM·M⁻²·sec⁻¹ for 7-14 days prior to calculating the success rate of the cryopreservation procedure.

The cryopreservation success rate was calculated by the total number of visible daughter fronds (or daughter fronds with viable tissue) to survive the freezing process and successfully reproduce new daughter fronds as a percentage of the total number of visible daughter fronds that were frozen. Viability of tissue or of daughter fronds was assessed by the presence of green tissue and the ability of these fronds or frond tissues to reproduce and generate new daughter fronds. Generally, the non-exposed tissue of the daughter frond that is protected by the pouch, created by a flap of protective tissue found on the mother frond, survives. This can comprise the meristematic region of the frond as well as additional differentiated tissue. This tissue will continue to grow and reproduce additional fronds within a 24-72 hour time period for 50-75% of the time. Daughter fronds for the remaining 25-50% of the time begin growing within 4-7 days post thaw. The cryopreservation success rate for Lemna minor ranged from 50-100%.

### Example 2

### Cryopreservation of Duckweed Transgenic Lines Expressing Plasminogen and Alpha-2b Interferon

The transgenic Lemna minor duckweed lines BAP01-B2-230 and IFN61-B2-101, expressing plasminogen and alpha-2b interferon, respectively, were cryopreserved with a procedure similar to that described in Example 1. A total of 30 vials containing three frond colonies of each transgenic line were frozen and stored in the vapor phase of liquid nitrogen for four days before being thawed and plated to determine the cryopreservation success rate. The success rate for the IFN61-B2-101 line was 78.4% and the BAP01-230 line was 61.4%.

In order to assess the genetic stability of the transgenic lines during the freezing process, the expression of the transgenes by recovered transgenic plants was measured. Two thawed daughter fronds obtained from separate mother fronds from each vial were grown in Schenk and Hildebrandt 1.2 media (photosynthetic) under light levels ranging from 200 μM·M⁻²·sec⁻¹ to 450 μM·M⁻²·sec⁻¹ for three two-week increments. A total of 58 samples of IFN61-B2-101 and 53 samples of BAP01-230 survived this process. A 100-mg tissue sample and 2×1-ml media samples were collected from each of the recovered IFN61-B2-101 lines. A 100 mg tissue sample and 2×250 mg tissue samples were collected from each of the recovered BAP01-230 lines. All samples were stored on ice until sampling was completed and then each sample was submerged in liquid nitrogen to snap freeze the material. The material was stored at −70° C. until the assays were completed. Standard ELISA assays were performed to detect and quantify the levels of expressed plasminogen protein and secreted interferon. Results are presented in Tables 1 and 2.

The plants were propagated for another 2-3 weeks, at which point, tissue samples were collected again and ELISA assays repeated. These results are presented in Tables 3 and 4.

The results demonstrate that two transgenic duckweed lines are able to express the transgene after the plant has been cryopreserved, thawed and recovered at comparable levels to plants that have not undergone the cryopreservation process. Therefore, the cryopreservation methods of the present invention maintain genetic stability and allow transgenic duckweed plants to retain the transgene and maintain expression of the heterologous polypeptide.

TABLE 1
Expression level of plasminogen by the cryopreserved transgenic duckweed
line BAP01-B2-230 following recovery and about 6 weeks in culture.

| | Total Soluble Protein (TSP) | |
|---|---|---|
| Cryoisolate | (mg/ml) in 250 mg tissue in 1 ml | Plasminogen (ng/ml) in |
| Number | extraction buffer | 10 μg/ml of TSP |
| Control* | 0.66 (for 100 mg tissue) | 88.01 |
| 1a | 1.25 | 132.70 |
| 1b | 1.11 | 138.65 |
| 2a | 1.26 | 131.32 |
| 2b | Non-viable | Non-viable |
| 3a | 1.29 | 115.03 |
| 3b | 1.26 | 130.00 |
| 4a | 1.12 | 148.50 |
| 4b | 1.20 | 116.58 |
| 5a | 1.32 | 164.77 |
| 5b | 1.31 | 131.47 |
| 6a | 1.57 | 125.69 |
| 6b | Non-viable | Non-viable |
| 7a | 1.12 | 116.70 |
| 7b | Non-viable | Non-viable |
| 8a | 1.32 | 119.65 |
| 8b | 1.85 | 121.75 |
| 9a | 1.21 | 142.53 |
| 9b | 1.24 | 117.64 |
| 10a | 1.02 | 140.00 |
| 10b | 0.60 | 169.75 |
| 11a | 1.07 | 133.43 |
| 11b | 1.30 | 116.95 |
| 12a | 1.17 | 117.71 |
| 12b | 1.09 | 132.10 |
| 13a | 1.44 | 119.65 |
| 13b | 1.17 | 124.01 |
| 14a | 0.55 | >Range |
| 14b | 0.87 | 122.82 |
| 15a | Non-viable | Non-viable |
| 15b | 1.37 | 138.69 |
| 16a | 1.47 | 135.72 |
| 16b | 1.37 | 118.84 |
| 17a | 1.25 | 155.21 |
| 17b | 1.43 | 156.58 |
| 18a | 1.12 | 179.31 |
| 18b | 1.29 | >Range |
| 19a | 1.23 | 137.74 |
| 19b | 1.20 | 126.27 |
| 20a | 1.66 | 134.27 |
| 20b | 0.96 | 117.40 |
| 21a | 1.12 | 124.74 |
| 21b | 1.20 | 136.80 |
| 22a | 1.19 | 130.00 |
| 22b | Non-viable | Non-viable |
| 23a | 0.95 | >Range |
| 23b | 1.26 | 127.38 |
| 24a | 1.04 | 131.84 |
| 24b | 1.38 | 107.28 |
| 25a | 1.37 | 112.59 |
| 25b | 1.22 | 132.67 |
| 26a | 1.35 | 148.00 |
| 26b | 1.48 | 135.96 |
| 27a | 1.25 | 176.91 |
| 27b | 0.85 | 147.70 |
| 28a | Non-viable | Non-viable |
| 28b | 1.13 | 121.08 |
| 29a | Non-viable | Non-viable |
| 29b | 0.89 | 136.24 |
| 30a | 1.02 | 123.71 |
| 30b | 1.23 | 148.40 |

*Control BAP01-B2-230 plant that has not been cryopreserved.
* >Range indicates the measurement was outside of the standard curve for this experiment.

TABLE 2
Expression level of alpha-2b interferon by the cryopreserved transgenic
duckweed line IFN61-B2-101 following recovery and about 6
weeks in culture.

| Cryovial Number | Interferon (μg/ml) |
|---|---|
| 1a | Non-viable |
| 1b | 4.61 |
| 2a | 4.39 |
| 2b | 4.59 |
| 3a | 5.49 |
| 3b | Non-viable |
| 4a | 4.86 |
| 4b | 4.76 |
| 5a | 5.37 |
| 5b | 5.56 |
| 6a | 5.20 |
| 6b | 4.58 |
| 7a | 4.63 |
| 7b | 5.29 |
| 8a | 4.97 |
| 8b | 4.19 |
| 9a | 4.34 |
| 9b | 4.52 |
| 10a | 4.79 |
| 10b | 4.40 |
| 11a | 4.11 |
| 11b | 4.54 |
| 12a | 4.99 |
| 12b | 4.54 |
| 13a | 5.00 |
| 13b | 4.58 |
| 14a | 4.68 |
| 14b | 4.64 |
| 15a | 4.66 |
| 15b | 4.78 |
| 16a | 4.74 |
| 16b | 4.01 |
| 17a | 4.32 |
| 17b | 3.61 |
| 18a | 4.12 |
| 18b | 3.73 |
| 19a | 4.06 |
| 19b | 4.06 |
| 20a | 3.43 |
| 20b | 3.73 |
| 21a | 3.73 |
| 21b | 3.74 |
| 22a | 3.55 |
| 22b | 3.27 |
| 23a | 3.44 |
| 23b | 3.40 |
| 24a | 3.46 |
| 24b | 3.35 |
| 25a | 3.50 |
| 25b | 3.56 |
| 26a | 3.54 |
| 26b | 3.43 |
| 27a | 3.57 |
| 27b | 3.43 |
| 28a | 3.58 |
| 28b | 3.48 |
| 29a | 3.83 |
| 29b | 3.95 |
| 30a | 3.81 |
| 30b | 3.63 |

TABLE 3
Expression level of plasminogen by the cryopreserved transgenic
duckweed line BAP01-B2-230 following about 9 weeks in culture.

| | Total Soluble Protein (TSP) | |
|---|---|---|
| Cryoisolate | (mg/ml) in 250 mg tissue in 1 | Plasminogen (ng/ml) in |
| Number | ml extraction buffer | 10 μg/ml of TSP |
| 1a | 0.85 | >Range |
| 1b | 1.08 | >Range |
| 2a | Non-viable | Non-viable |
| 2b | 1.08 | >Range |
| 3a | 1.13 | >Range |
| 3b | 1.17 | >Range |
| 4a | 1.13 | >Range |
| 4b | 1.39 | >Range |
| 5a | 1.11 | >Range |
| 5b | 1.12 | >Range |
| 6a | 1.19 | 140.17 |
| 6b | 1.07 | >Range |
| 7a | 0.94 | >Range |
| 7b | Non-viable | Non-viable |
| 8a | 1.01 | >Range |
| 8b | 1.04 | >Range |
| 9a | 1.00 | >Range |
| 9b | 1.12 | >Range |
| 10a | 0.99 | >Range |
| 10b | Non-viable | Non-viable |
| 11a | 1.11 | 140.43 |
| 11b | 0.83 | >Range |
| 12a | 1.26 | >Range |
| 12b | 1.32 | >Range |
| 13a | 0.95 | >Range |
| 13b | 1.16 | >Range |
| 14a | 1.10 | >Range |
| 14b | 1.03 | >Range |
| 15a | 1.04 | 167.85 |
| 15b | Non-viable | Non-viable |
| 16a | 1.32 | >Range |
| 16b | 1.22 | >Range |
| 17a | 1.78 | >Range |
| 17b | 1.42 | >Range |
| 18a | 1.07 | >Range |
| 18b | 1.04 | >Range |
| 19a | 1.05 | >Range |
| 19b | 1.18 | >Range |
| 20a | 1.10 | >Range |
| 20b | Non-viable | Non-viable |
| 21a | 1.06 | >Range |
| 21b | 1.15 | >Range |
| 22a | 0.93 | >Range |
| 22b | 1.24 | >Range |
| 23a | 1.06 | >Range |
| 23b | 1.28 | >Range |
| 24a | 1.14 | 147.75 |
| 24b | 0.93 | >Range |
| 25a | 1.05 | >Range |
| 25b | 1.06 | >Range |
| 26a | 1.10 | >Range |
| 26b | 1.01 | >Range |
| 27a | 0.83 | >Range |
| 27b | Non-viable | Non-viable |
| 28a | Non-viable | Non-viable |
| 28b | 1.18 | >Range |
| 29a | Non-viable | Non-viable |
| 29b | 1.36 | 143.83 |
| 30a | 1.07 | 131.05 |
| 30b | 0.96 | 166.89 |

* >Range indicates the measurement was outside of the standard curve for this experiment.

TABLE 4
Expression level of alpha-2b interferon by the cryopreserved transgenic
duckweed line IFN61-B2-101 following about 9 weeks in culture.

| Cryovial Number | Interferon (μg/ml) |
|---|---|
| 1a | Non-viable |
| 1b | 4.24 |
| 2a | 4.50 |
| 2b | 3.89 |
| 3a | Non-viable |
| 3b | 4.29 |
| 4a | 4.22 |
| 4b | 4.01 |
| 5a | 3.86 |
| 5b | 4.07 |
| 6a | 4.14 |
| 6b | 3.78 |
| 7a | 4.14 |
| 7b | 3.98 |
| 8a | 4.99 |
| 8b | 4.23 |
| 9a | 4.39 |
| 9b | 3.74 |
| 10a | 3.60 |
| 10b | 3.48 |
| 11a | 3.61 |
| 11b | 4.20 |
| 12a | 4.62 |
| 12b | 4.35 |
| 13a | 4.89 |
| 13b | 3.75 |
| 14a | 3.67 |
| 14b | 3.32 |
| 15a | 3.30 |
| 15b | 3.60 |
| 16a | 3.47 |
| 16b | 3.63 |
| 17a | 4.69 |
| 17b | 4.02 |
| 18a | 3.25 |
| 18b | 3.57 |
| 19a | 3.57 |
| 19b | 3.33 |
| 20a | 3.92 |
| 20b | 3.72 |
| 21a | 4.09 |
| 21b | 4.03 |
| 22a | 3.83 |
| 22b | 3.49 |
| 23a | 3.49 |
| 23b | 3.63 |
| 24a | 3.47 |
| 24b | 3.79 |
| 25a | 3.79 |
| 25b | 3.82 |
| 26a | 3.61 |
| 26b | 3.55 |
| 27a | 3.60 |
| 27b | 3.58 |
| 28a | 4.74 |
| 28b | 4.60 |
| 29a | 4.22 |
| 29b | 4.22 |
| 30a | >Range |
| 30b | 4.72 |

* >Range indicates the measurement was outside of the standard curve for this experiment.

### Example 3

### Cryopreservation of Multiple Species of Duckweed from the Genus Lemna and One Species from the Genus Landoltia

Duckweed plants of the species Lemna aequinoctialis, Lemna disperma, Lemna gibba, Lemna japonica, Lemna minor, Lemna minuta, Lemna perpusilla, Lemna tenera, Lemna trisulca, Lemna turionifera, Lemna yungensis, Lemna valdiviana, Landoltia punctata were prepared and frozen with a similar protocol as that disclosed in Example 1. However, these plants were not pre-acclimated with Schenk and Hildebrandt media, supplemented with 20 mg/ml sucrose prior to the dormancy-induction step.

For each species, three vials were prepared for cryopreservation, each comprising at least two duckweed frond colonies, each of which comprised at least one mother frond with at least one attached daughter frond.

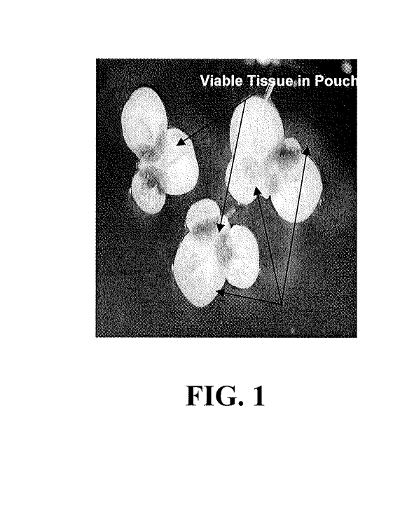

The duckweed frond colonies were frozen in the vapor phase of liquid nitrogen for 5 days. The frond colonies were then thawed and allowed to recover for 8 days, at which point the success rate was quantified in a manner similar to Example 1 (see Table 5). Photographs of the recovered frond colonies were captured immediately after thawing, and at 3 days, and 8 days post-thaw (see, for example, FIG. 1; other available photographs not shown).

TABLE 5
Viability of frozen and thawed duckweed lines.

| | | 8-day | | Percent |
|---|---|---|---|---|
| | Vial | success rate | Total 8-day | success r |
| Species | Number | per vial | success rate | ate (%) |
| Lemna aequinoctialis | 1 | 0/6 | 0/18 | 0 |
| | 2 | 0/6 | | |
| | 3 | 0/6 | | |
| Lemna disperma * | 1 | 0/6 | 0/18 | 0 |
| | 2 | 0/6 | | |
| | 3 | 0/6 | | |
| Lemna gibba * | 1 | 0/8 | 0/20 | 0 |
| | 2 | 0/6 | | |
| | 3 | 0/6 | | |
| Lemna japonica | 1 | 1/8 | 3/28 | 10.7 |
| | 2 | 1/10 | | |
| | 3 | 1/10 | | |
| Lemna minor | 1 | 5/12 | 13/28 | 46.4 |
| | 2 | 3/6 | | |
| | 3 | 5/10 | | |
| Lemna minuta * | 1 | 5/16 | 11/42 | 26.2 |
| | 2 | 4/16 | | |
| | 3 | 2/10 | | |
| Lemna perpusilla | 1 | 0/6 | 0/18 | 0 |
| | 2 | 0/6 | | |
| | 3 | 0/6 | | |
| Lemna tenera | 1 | 0/6 | 0/18 | 0 |
| | 2 | 0/6 | | |
| | 3 | 0/6 | | |
| Lemna trisulca * | 1 | 4/8 | 11/24 | 45.8 |
| | 2 | 5/6 | | |
| | 3 | 2/10 | | |
| Lemna turionfera * | 1 | 0/8 | 1/32 | 3.1 |
| | 2 | 0/12 | | |
| | 3 | 1/12 | | |
| Lemna yungensis | 1 | 0 | 0 | 0 |
| | 2 | 0 | | |
| | 3 | 0 | | |
| Lemna valdiviana * | 1 | 2/8 | 11/30 | 36.7 |
| | 2 | 6/12 | | |
| | 3 | 3/10 | | |
| Landoltia punctata | 1 | 3/8 | 20/38 | 52.6 |
| | 2 | 3/4 | | |
| | 3 | 3/4 | | |
| | 4 | 2/4 | | |
| | 5 | 3/6 | | |
| | 6 | 1/4 | | |
| | 7 | 2/4 | | |
| | 8 | 3/4 | | |

* These recovered plants exhibited microbial contamination, which might have decreased the cryopreservation success rate.

Several of the lines experienced microbial contamination, which might have hindered the growth of these plants. In addition, these numbers would likely improve if a pretreatment step was included and the plants were allowed to become acclimated to the sugar solution used during the dormancy-induction step. In fact, in additional experiments with a pre-treatment step, L. aequinoctialis, L. gibba, and L. tenera were successfully cryopreserved (available photographs not shown).

### Example 4

### Cryopreservation of Various Duckweed Species with Varying Sugar Concentration, Temperature, and Light Conditions During the Dormancy-Induction Step

Duckweed frond colonies were cryopreserved following the procedures outlined in Example 1, however, the frond colonies were cultured in Schenk and Hildebrandt media supplemented with: the six sugar combination disclosed in Example 1 (comprising 15 mg/ml of each raffinose, trehalose, mannitol, sorbitol, sucrose, and glucose), 20 mg/ml sucrose, 90 mg/ml glucose, 90 mg/ml mannitol, 90 mg/ml sucrose, 90 mg/ml sorbitol, 90 mg/ml raffinose, or 90 mg/ml trehalose. The duckweed species tested in the first set of experiments were L. sp. Branson (which is a Duckweed line provided by Dr. Branson that might be a Lemna minor or Lemna japonica species), L. minor, Sp. polyrrhiza, L. yungensis, L. perpussilla, L. disperma, and Wl. welwitschii. None of the L. perpussilla, L. disperma, and Wl. welwitschii fronds survived the cryopreservation process. The cryopreservation success rates for the other duckweed species tested in this first set of experiments are presented in Table 6 immediately below.

TABLE 6
Cryopreservation success rates of Duckweed species in media with
various sugars.

| | L. sp. | | | L. |
|---|---|---|---|---|
| Treatment | Branson | L. minor | Sp. polyrrhiza | yungensis |
| Glucose | 88.5% (23/26) | 5.9% (1/17) | 0% (0/4) | 0% |
| Mannitol | 33.3% (6/18) | 0% (0/8) | 50% (4/8) | 1 frond |
| Sucrose | 100% (23/23) | 36.8% (7/19) | 0% (0/10) | 0% |
| Sorbitol | 27.3% (6/22) | 0% (0/13) | 12.5% (1/8) | 1 frond |
| Raffinose | 100% (23/23) | 100% (16/16) | 0% (0/6) | 0% |
| Trehalose | 100% (20/20) | 100% (17/17) | 0% (0/4) | 0% |
| 20 mg/ml | 96% (24/25) | 42.3% (11/26) | 0% (0/14) | 0% |
| Sucrose | | | | |
| Six Sugar | 100% (23/23) | 68.8% (11/16) | 0% (0/4) | 0% |
| Combo | | | | |

A second set of experiments were performed exactly as those described immediately above, however, these experiments did not include L. disperma, but did include Wl. cylindraceae. Once again, none of the L. perpussilla and Wl. welwitschii fronds survived the cryopreservation procedure, whereas Wa. cylindracea had 1/14 fronds or 7.14% of fronds survive the procedure using the six sugar combination. The success rates for the other species are presented in Table 7 immediately below. Photographs of recovered L. yungensis and Sp. polyrrhiza frond colonies from these experiments were captured (not shown).

TABLE 7
Cryopreservation success rates of Duckweed species in media
with various sugars.

| | L. sp. | | | L. |
|---|---|---|---|---|
| Treatment | Branson | L. minor | Sp. polyrrhiza | yungensis |
| Glucose | 53.3% (8/15) | 53.9% (7/13) | 0% (0/4) | 0% |
| Mannitol | 28.6% (4/14) | 0% (0/14) | 57.1% (4/7) | 2 fronds |
| Sucrose | 87.5% (14/16) | 91.7% (11/12) | N/A | 0% |
| Sorbitol | 16.7% (2/12) | 0% (0/4) | 25% (1/4) | 1 frond |
| Raffinose | 100% (17/17) | 92.9% (13/14) | 0% (0/12) | 0% |
| Trehalose | 100% (16/16) | 85.7% (12/14) | 0% (0/15) | 0% |
| 20 mg/ml | 88.2% (15/17) | 43.8% (7/16) | 0% (0/12) | 0% |
| Sucrose | | | | |
| Six Sugar | 78.6% (11/14) | 76.9% (10/13) | 0% (0/12) | 0% |
| Combo | | | | |

N/A: Not available this sample was misplaced.

The Lemna sp. Branson line can be successfully cryopreserved with any of the tested sugar solutions although the cryopreservation success rates for mannitol and sorbitol are low relative to the other sugars that were tested. L. minor prefers raffinose, trehalose, or the six sugar combination, and exhibited lower cryopreservation success rates with glucose and sucrose, whereas mannitol and sorbitol were ineffective. Interestingly, out of the conditions tested, Sp. polyrrhiza and L. yungensis can only be successfully cryopreserved in the presence of mannitol or sorbitol.

An experiment was performed to test the concentration of individual sugars in the media during the dormancy-induction step that allows successful cryopreservation of the L. sp. Branson, L. minor, BAP01-B2-230, and IFN61-B2-101 lines. This experiment did not include treatments with sorbitol or mannitol alone due to the low success rates for these sugars (see Tables 6 and 7). Each sugar (glucose, raffinose, sucrose, and trehalose) was tested at concentrations of 90 mg/ml (1×) and 270 mg/ml (3×). Cryopreservation success rates are presented in Table 8 found immediately below.

TABLE 8
Cryopreservation success rates of duckweed species in media with
various sugars at two concentrations.

| | L. sp. | | | |
|---|---|---|---|---|
| Treatment | Branson | L. minor | BAP 230 | IFN61 |
| Glucose 1X | 0% (0/11) | 0% (0/12) | 0% (0/14) | 5.3% |
| | | | | (1/19) |
| Glucose 3X | 0% (0/15) | 0% (0/16) | 0% (0/13) | 0% |
| | | | | (0/22) |
| Raffinose 1X | 100% (20/20) | 96% (24/25) | 96.2% (25/26) | 100% |
| | | | | (14/14) |
| Raffinose 3X | 0% (0/12) | 0% (0/19) | 0% (0/14) | 26.7% |
| | | | | (4/15) |
| Sucrose 1X | 100% (19/19) | 88.9% (16/18) | 100% (16/16) | 89.5% |
| | | | | (17/19) |
| Sucrose 3X | 0% (0/14) | 0% (0/11) | 0% (0/12) | 0% |
| | | | | (0/14) |
| Trehalose 1X | 100% (17/17) | 100% (15/15) | 85% (17/20) | 93.8% |
| | | | | (15/16) |
| Trehalose 3X | 0% (0/17) | 0% (0/12) | 0% (0/12) | 7.1% |
| | | | | (1/14) |

Thus, glucose at a 1× concentration was only successful in cryopreserving the IFN61-B2-101 line. Raffinose, sucrose, and trehalose at a 1× concentration successfully cryopreserved all four lines. The 3× treatment for glucose and sucrose did not produce any successful cryopreserved fronds for all four lines. The 3× treatment for raffinose and trehalose only successfully cryopreserved the IFN61-B2-101 line with a relatively low success rate.

Another set of experiments measured the effects of various total sugar concentrations of the six sugar combination in the culture media during the dormancy induction step on the ability to cryopreserve the L. sp. Branson, L. minor, and the BAP01-B2-230 and IFN61-B2-101 lines. Schenk and Hildebrandt media with 20 mg/ml sucrose, 1× six sugar combination (15 mg/ml each of sucrose, glucose, raffinose, trehalose, mannitol, and sorbitol with a total sugar concentration of 90 mg/ml), 2.4× six sugar combination (36 mg/ml each sugar with a total sugar concentration of 216 mg/ml), or the 3.8× six sugar combination (57 g each sugar with a total sugar concentration of 342 mg/ml). The results are presented in Table 9 shown immediately below.

TABLE 9
Cryopreservation success rates of duckweed species in media with
various concentrations of the six sugar combination.

| | L. sp. | | | IFN61- |
|---|---|---|---|---|
| Treatment | Branson | L. minor | BAP01-230 | B2-101 |
| 20 mg/ml | 100% (24/24) | 92.9% (26/28) | 60.9% (14/23) | 100% |
| sucrose | | | | (17/17) |
| 1X Six | 96.2% (25/26) | 100% (20/20) | 94.1% (16/17) | 50% (6/12) |
| Sugar | | | | |
| Combo | | | | |
| 2.4X Six | 0% (0/14) | 0% (0/16) | 0% (0/12) | 0% (0/12) |
| Sugar | | | | |
| Combo | | | | |
| 3.8X Six | 0% (0/20) | 0% (0/18) | 0% (0/12) | 0% (0/12) |
| Sugar | | | | |
| Combo | | | | |

Only the six sugar combo with the total concentration of 90 mg/ml of sugars was successful in cryopreserving these duckweed species.

Additional experiments were performed to further define the requirements for successful cryopreservation of Lemna minor duckweed plants. The length of the dormancy induction step was shortened to determine the minimum length of time that a duckweed frond colony can be cultured under dormancy inducing conditions. The dormancy-induction step was performed for 7 days, 14 days, 21 days, or 28 days. The temperature and light exposure during the dormancy induction step was also varied. Duckweed frond colonies were cultured at about 4° C. or about 9-10° C. in the absence of light. Alternatively, the frond colonies were cultured under fluctuating temperatures in the absence of light, wherein the temperature was about 10° C. for 3 hours, followed by about 15° C. for 6 hours, about 10° C. for 3 hours, and then the colonies were exposed to about 4° C. for 12 hours. Each 24-hour cycle comprised a day and was repeated for 7, 14, 21, or 28 days. The last tested dormancy-induction condition involved exposure of the frond colonies to fluctuating temperatures and fluctuating light conditions. The colonies were exposed to a short-day/long-night photoperiod comprised of: 10° C. at a light level of 25-50 μM·M⁻²·sec⁻¹ for 3 hours, 6 hours at 15° C. at a light level of 25-75 μM·M⁻²·sec⁻¹, 3 hours at 10° C. at a light level of 25-50 μM·M⁻²·sec⁻¹, wherein the difference in the light level between the first and second time periods and second and third time periods was at least 5 μM·M⁻²·sec⁻¹. The nighttime hours of the short-day/long-night photoperiod comprised 12 hours at about 4° C. in the absence of light. The concentration and type of sugars in the incubation medium during the dormancy-induction step was also varied. The frond colonies were either incubated in Schenk and Hildebrandt medium in the absence of sugars, Schenk and Hildebrandt with 20 mg/ml sucrose, or Schenk and Hildebrandt with 90 mg/ml each of raffinose, trehalose, mannitol, sorbitol, glucose, and sucrose (six sugar combo). The cryopreservation success rates of Lemna minor with these various dormancy-induction conditions are presented in Table 10 immediately below.

TABLE 10
Cryopreservation success rates of L. minor.

| | | | | |
|---|---|---|---|---|
| Treatment | 7-Day | 14-Day | 21-Day | 28-Day |

4° C. with no light

| | | | | |
|---|---|---|---|---|
| No sugar | 4.55% (1/22) | 9.38% (3/32) | 9.52% (2/21) | 21.43% (6/28) |
| 20 mg/ml sucrose | 0% (0/28) | 0% (0/22) | 4.17% (1/24) | 0% (0/20) |
| Six sugar combo | 0% (0/26) | 0% (0/18) | 0% (0/20) | 0% (0/21) |

9-10° C. with no light

| | | | | |
|---|---|---|---|---|
| No sugar | 11.54% (3/26) | 63.64% (14/22) | 73.91% (17/23) | 24% (6/25) |
| 20 mg/ml sucrose | 14.82% (4/27) | 73.08% (19/26) | 91.67% (22/24) | 97.37% (37/38) |
| Six sugar combo | 50% (13/26) | 60% (15/25) | 65.52% (19/29) | 50% (13/26) |

Fluctuating temperature with no light

| | | | | |
|---|---|---|---|---|
| No sugar | 0% (0/30) | 85.71% (24/28) | 75% (24/32) | 100% (21/21) |
| 20 mg/ml sucrose | 65.39% (17/26) | 100% (24/24) | 86.96% (20/23) | 100% (30/30) |
| Six sugar combo | 20.83% (5/24) | 55.56% (15/27) | 66.67% (18/27) | 72.73% (16/22) |

Fluctuating temperature and light

| | | | | |
|---|---|---|---|---|
| No sugar | 0% (0/27) | 14.29% (5/35) | 60.53% (23/38) | 90.91% (30/33) |
| 20 mg/ml sucrose | 33.3% (9/27) | 96% (24/25) | 93.75% (30/32) | 94.29% (33/35) |
| Six sugar combo | 33.3% (8/24) | 74.07% (20/27) | 79.17% (19/24) | 76.92% (20/26) |

These results show that Lemna minor can be successfully frozen using a 7-day dormancy-induction step with no sugar at 4° C. and up to 28 days using a dormancy-induction step with a short-day/long-night photoperiod and fluctuating temperatures. The fronds also can be cryopreserved with a dormancy-induction step lasting as little as 7 days using any of the three solutions in a 9-10° C. environment or with fluctuating temperatures in the absence of light.

In sum, 10 of the 12 Lemna species and 4 out of the 5 duckweed genera that were tested were able to be successfully cryopreserved using the presently disclosed methods. Photographs of cryopreserved Lemna trisulca, Lemna turionfera, Lemna valdiviana, the Lemna sp. Branson, Wolffia cylindracea, and Wolfiella welwitschii duckweed plants that were cryopreserved, thawed, and cultured using the presently disclosed methods were captured (not shown).

### Example 5

### Testing the Cryopreservation Success Rate of Exposed Duckweed Meristematic Tissue

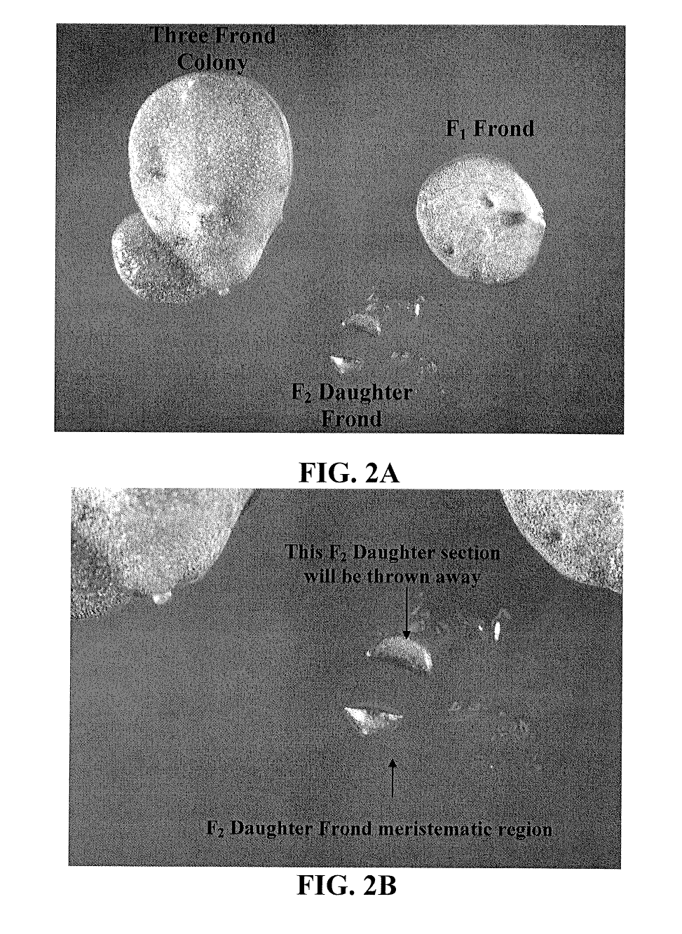

The IFN61-B2-101 Lemna minor line described in Example 2 was used for these experiments. IFN61-B2-101 was continuously grown on 2% Schenk and Hildebrandt media. A total of 32 vials were inoculated with three frond colonies, each comprised of three fronds, and were subjected to the sugar solution and the light and temperature cycles described in Example 1 for 28 days. Following the 28-day incubation period, meristematic tissue was excised from fronds on a plate comprising 1% Schenk and Hildebrandt media with 1% agar in a laminar flow hood with or without the use of a dissecting scope. A number 10 scalpel blade was used to carefully remove a single mother frond (F₁) from a frond colony, from which the daughter frond (F₂) was removed (see FIGS. 2A and 2B). A cut was made to the middle to lower third of the F₂ frond to excise the meristematic tissue within the lower half or lower third of the frond (see FIGS. 2A and 2B). Although this tissue is referred to as meristematic tissue, in some cases, the excised region also includes more differentiated tissue.

To determine how the excision process might be affecting the viability of the tissue, meristematic tissue was excised from Lemna minor F₂ fronds as described herein above, and the excised tissue was plated on plates with 10 mg/ml sucrose and 1% (w/v) agar in Schenk and Hildebrandt media. The survival rate was assessed seven days later. In this experiment, 19/21 or 90.5% of the excised meristems survived the mechanical process of excision.

The meristematic tissue was added to a vial comprising 900 μL of the cryoprotective solution described in Example 1. Approximately seven meristems were added to each of three vials. After an incubation at approximately 4° C. for 30 minutes, the vials were frozen in a slow rate freezer using the stepwise procedure outlined in Example 1.

As a control, the sugar solution was removed from vials comprising frond colonies, and was replaced with the 900 μL of cryoprotective solution prior to being subjected to the same freezing protocol.

Following a 35-day incubation, all vials were removed from the freezer, thawed for ten minutes at room temperature, and then rinsed five times in Schenk and Hildebrandt media supplemented with 1.2 M sucrose.

As a further control, frond colonies and meristematic tissue were prepared as above and the tissue samples were treated according to the above protocol, except the tissues and plants were not frozen. The cryoprotective solution was not replaced in all of the vials with meristematic tissue because the tissue was sticking to the pipette tips, leading to loss of tissue.

Following the replacement of the cryoprotective solution, all samples were plated on Schenk and Hildebrandt medium with 10 mg/ml sucrose and 1% (w/v) agar and cultured at an aerial temperature of between about 21° C. and about 30° C. with light levels ranging from about 20 μM·M⁻²·sec⁻¹ to about 100 μM·M⁻²·sec⁻¹. The success rate of the cryopreservation was measured at day seven and day 14. In all cases, the success rates at day 7 and day 14 were the same. Results are shown in Table 11.

TABLE 11
Cryopreservation success rates of IFN61-B2-101 L. minor frond
colonies and meristematic tissues.

| | Unfrozen | | Frozen | |
|---|---|---|---|---|
| | | Meristematic | | Meristematic |
| Vial No. | Frond Colony | Tissue | Frond Colony | Tissue |
| 1 | 100% (8/8) | 33.3% (2/6*) | 83.3% (5/6) | 0% (0/5) |
| 2 | 100% (7/7) | 80.0% (4/5*) | 83.3% (5/6) | 12.5% (1/8*) |
| 3 | 100% (7/7) | 66.7% (4/6) | 66.7% (6/9*) | 0% (0/8) |
| Mean | 100% (22/22) | 58.8% (10/17) | 76.2% (16/21) | 4.8% (1/21) |

*In each of these treatment groups, there existed one additional frond or tissue that appeared green, but did not grow.

Table 11 shows that the cryopreservation success rate of the frond colony is 76.2%, whereas the success rate of exposed meristematic tissue is only 4.8%. A photograph of thawed, meristematic tissue after a 14-day incubation on a Schenk and Hildebrandt/10 mg/ml sucrose/1% agar plate was captured (not shown). When the excised meristematic tissue is treated following the cryopreservation protocol described in Example 1 without freezing, the success rates were higher than the tissue that had been frozen, but lower than the unfrozen frond colony controls.

It is possible that the survival of one meristem after cryopreservation could be due to the fact that the tissue could have folded in on itself to protect all or part of the meristematic tissue, mimicking the protection afforded by the mother frond.

In all experiments conducted using frond colonies (instead of excised tissue), the tissue that survives the cryopreservation process is the tissue that is enclosed within the pouch of the mother frond. The unprotected tissue exposed to the cryoprotective solution during the freezing process will senesce and die within 24 to 48 hours. Thus, when the meristematic tissue is exposed to cryoprotective solution and the stress caused by freezing, the survival rate is very low.

### Example 6

### Cryopreserving Duckweed Plants or Duckweed Plant Tissues Using an Encapsulation/Dehydration Process

Duckweed frond colonies undergo a dormancy-induction step in a sugar solution. Duckweed frond colonies are further dehydrated by an incubation in a concentrated sugar solution (sucrose, raffinose, trehalose, etc.) in a liquid or agar-based media for a period of time in different temperatures and light levels to maximize the removal of water and minimize the stress to the plant. The frond colonies are then encapsulated with a 2% (or higher) alginate in Schenk and Hildebrandt media, followed by an incubation in a 0.1 M calcium chloride solution for 60 to 90 minutes to harden the beads.

Alternatively, following a dormancy-induction step in a sugar solution, the duckweed frond colonies are encapsulated with 2% alginate in Schenk and Hildebrandt media and incubated in a 0.1 M calcium chloride solution for 60 to 90 minutes to harden the beads. The encapsulated fronds are placed under air or incubated with silica gel in an enclosed container to dry the fronds. The length of time is varied to increase or decrease the drying time depending on the success rates. The beads from either of these methods are transferred to cryovials and frozen.

### Example 7

### Cryopreserving Duckweed Plants or Duckweed Tissue Using Sugar Dehydration and a Rapid Freezing Process

Duckweed frond colonies undergo a dormancy-induction step in a sugar solution.

To further dehydrate duckweed frond colonies, the frond colonies are added to a Schenk and Hildebrandt solution with or without agar which contains concentrated amounts of one or more sugars. These sugars are the standard six sugars used in the dormancy-induction step described in Example 1 or other sugars. The length of time, temperature, and light levels during this process is varied to determine the optimal time need to dehydrate the tissue.

When the optimal dehydration time is obtained, the fronds are transferred to vials containing no solution to prevent the seeding of ice crystals. The dehydrated duckweed frond colony is frozen rapidly. Extremely rapid freezing and thawing steps help reduce ice crystal damage. Generally, the more water present in the tissue, the faster the tissue must be frozen and thawed to minimize the ice crystal damage to the cells.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the foregoing list of embodiments and appended claims. Although specific terms are employed herein, they are used in a generic and descriptive sense only and not for purposes of limitation.

1. A method for cryopreserving a duckweed plant or duckweed plant tissue, wherein said method comprises dehydrating a duckweek frond colony to produce a dehydrated duckweed frond colony, and freezing said a dehydrated duckweed frond colony to a cryopreservative temperature, wherein said duckweed frond colony comprises more than one duckweed plant, to obtain a frozen frond colony comprising at least one cryopreserved duckweed plant or a cryopreserved duckweed plant tissue, wherein said method further comprises a dormancy-induction step prior to or during said dehydrating.

2. (canceled)

3. The method of claim 1, wherein said duckweed plant or duckweed plant tissue is selected from the group consisting of Lemna minor, Lemna minuta, Lemna aequinoctialis, Lemna gibba, Lemna japonica, Lemna tenera, Lemna trisulca, Lemna turionfera, Lemna valdiviana, Lemna yungensis, Wolffia cylindracea, Spirodela polyrrhiza, and Landoltia punctata.

4. (canceled)

5. The method of claim 1, wherein said dehydrating comprises incubating a duckweed frond colony in a cryoprotective solution, thereby producing said dehydrated duckweed frond colony.

6-8. (canceled)

9. The method of claim 5, wherein said cryoprotective solution comprises dimethyl sulfoxide, ethylene glycol, glycerol, and sucrose.

10-11. (canceled)

12. The method of claim 1, wherein said dormancy-induction step has a duration of between about 7 days and about 28 days.

13-14. (canceled)

15. The method of claim 1, wherein said dormancy-induction step comprises culturing said duckweed frond colony under a cool temperature regime.

16. The method of claim 15, wherein said cool temperature regime comprises a temperature of between about 2° C. and about 25° C.

17-38. (canceled)

39. The method of claim 1, wherein said dormancy-induction step comprises culturing said duckweed frond colony in a sugar solution.

40. The method of claim 39, wherein said sugar solution comprises at least one sugar selected from the group consisting of trehalose, sucrose, sorbitol, raffinose, glucose, mannitol, and derivatives thereof.

41-42. (canceled)

43. The method of claim 1, further comprising a pretreatment step prior to the dormancy-induction step, wherein said pretreatment step comprises culturing a duckweed plant in a pretreatment medium to obtain said duckweed frond colony, wherein said pretreatment medium comprises a sugar or a combination of sugars.

44. (canceled)

45. The method of claim 43, wherein said sugar or combination of sugars comprises one or more sugars selected from the group consisting of trehalose, sucrose, sorbitol, raffinose, glucose, mannitol, and derivatives thereof.

46-47. (canceled)

48. The method of claim 1, wherein said dehydrated duckweed frond colony is in a cryoprotective solution during said freezing.

49. (canceled)

50. The method of claim 48, wherein said cryoprotective solution comprises dimethyl sulfoxide, ethylene glycol, glycerol, and sucrose.

51-52. (canceled)

53. The method of claim 1, wherein said freezing comprises cooling said dehydrated duckweed frond colony in a slow-cooling process to said cryopreservative temperature.

54. The method of claim 53, wherein said slow-cooling process comprises cooling said duckweed frond colony as follows:
a) cooling to about 4° C.;
b) cooling to about −4° C. at about 1° C. per minute;
c) cooling to about −40° C. at about 25° C. per minute;
d) heating to about −12° C. at about 10° C. per minute;
e) cooling to about −40° C. at about 1° C. per minute;
f) cooling to about −90° C. at about 10° C. per minute; and
g) cooling to about −150° C. at about 10° C. per minute.

55-57. (canceled)

58. The method of claim 1, wherein said duckweed frond colony, duckweed plant or duckweed plant tissue comprises a heterologous polynucleotide of interest that encodes a heterologous polypeptide of interest.

59. (canceled)

60. The method of claim 58, wherein said heterologous polypeptide of interest is selected from the group consisting of insulin, growth hormone, α-interferon, β-interferon, β-glucocerebrosidase, β-glucoronidase, retinoblastoma protein, p53 protein, angiostatin, leptin, erythropoietin, granulocyte macrophage colony stimulating factor, plasminogen, microplasminogen, tissue plasminogen activator, Factor VII, Factor VIII, Factor IX, activated protein C, alpha 1-antitrypsin, monoclonal antibodies, Fab fragments, single-chain antibodies, cytokines, receptors, hormones, human vaccines, animal vaccines, peptides, and serum albumin.

61. The method of claim 1, further comprising a recovery step, wherein said frozen duckweed frond colony is thawed and processed to obtain at least one recovered viable duckweed plant or duckweed plant tissue.

62. The method of claim 61, wherein said frozen duckweed frond colony is thawed at a temperature of between about 15° C. and about 40° C.

63. (canceled)

64. The method of claim 61, wherein said frozen duckweed frond colony is exposed to a recovery medium comprising a cryoprotective agent, wherein said cryoprotective agent in said recovery medium is a sugar or a combination of sugars.

65-86. (canceled)
